(19) United States
(12) Patent Application Publication
(10) Pub. No.: US 2025/0280035 A1
(43) Pub. Date: Sep. 4, 2025

(54) METHOD FOR DETECTING ATTACK TRAFFIC AND RELATED DEVICE

(71) Applicant: HUAWEI TECHNOLOGIES CO., LTD., Shenzhen (CN)

(72) Inventors: Bo WU, Beijing (CN); Haigang ZHANG, Hangzhou (CN); Li YANG, Beijing (CN)

(21) Appl. No.: 19/203,847

(22) Filed: May 9, 2025

Related U.S. Application Data
(63) Continuation of application No. PCT/CN2023/126565, filed on Oct. 25, 2023.

(30) Foreign Application Priority Data
Nov. 11, 2022 (CN) 202211414736.4
Jan. 19, 2023 (CN) 202310119197.X

(51) Int. Cl. H04L 9/40

(52) U.S. Cl. CPC H04L 63/1458; H04L 63/0236; H04L 63/1425

(57) ABSTRACT

This application discloses a method for detecting attack traffic and a related device. The method may be applied to a security protection device. The security protection device obtains a first rate representation value of first traffic in a first time period, where the first traffic includes at least one first data stream, and destination IP addresses of all first data streams are the same, or a destination IP address of the at least one first data stream belongs to one IP group. Then, the security protection device generates at least one fingerprint based on the first rate representation value, where each fingerprint is generated based on a packet field of one of the at least one first data stream, and any fingerprint is used to detect whether a data stream that matches the any fingerprint is attack traffic. The method can improve detection accuracy of attack traffic.

### CROSS-REFERENCE TO RELATED APPLICATIONS

This application is a continuation of International Application No. PCT/CN2023/126565, filed on Oct. 25, 2023, which claims priority to Chinese Patent Application No. 202211414736.4, filed on Nov. 11, 2022, and Chinese Patent Application No. 202310119197.X, filed on Jan. 19, 2023. All of the aforementioned patent applications are hereby incorporated by reference in their entireties.

### TECHNICAL FIELD

This application relates to the field of network security technologies, and in particular, to a method for detecting attack traffic and a related device.

### BACKGROUND

In recent years, distributed denial of service (DDOS) attacks launched by data streams encrypted based on the Transport Layer Security (TLS) protocol (referred to as TLS data streams for short) on a server are increasingly frequent. To ensure normal running of the server, a security protection device (for example, a firewall) needs to filter TLS data streams sent to the server. In other words, the security protection device detects whether the TLS data streams are attack traffic. When a TLS data stream is not attack traffic, the security protection device forwards the TLS data stream to the server. When a TLS data stream is attack traffic, the security protection device blocks the TLS data stream.

The security protection device may determine, by matching a fingerprint of a TLS data stream with a preset fingerprint database, whether the TLS data stream is attack traffic, where the preset fingerprint database is obtained by analyzing a known DDOS attack tool. However, accuracy of the preset fingerprint database is low, and consequently detection accuracy of attack traffic is low.

### SUMMARY

This application provides a method for detecting attack traffic and a related device, to improve detection accuracy of attack traffic.

According to a first aspect, this application provides a method for detecting attack traffic. The method may be applied to a security protection device. The security protection device obtains a first rate representation value of first traffic in a first time period. The first traffic includes at least one first data stream, and destination Internet Protocol (IP) addresses of all first data streams are the same, or a destination IP address of the at least one first data stream belongs to one IP group. Then, the security protection device generates at least one fingerprint based on the first rate representation value. Each fingerprint is generated based on a packet field of one of the at least one first data stream. Any fingerprint is used to detect whether a data stream that matches the any fingerprint is attack traffic.

In the technical solution provided in this application, the security protection device may obtain a fingerprint in real time based on a data stream, in other words, the fingerprint is dynamically obtained. The dynamically obtained fingerprint can better reflect a status of an ongoing attack. Therefore, when the dynamically obtained fingerprint is used to detect attack traffic, detection accuracy of the attack traffic can be provided. Further, when the dynamically obtained fingerprint is used to detect the attack traffic, only a fingerprint of a to-be-detected data stream needs to be compared with the dynamically obtained fingerprint, and an encrypted data stream does not need to be decrypted. This avoids occupation of a computing resource for decrypting the data stream, and avoids impact on user privacy security.

With reference to the first aspect, in an embodiment, the first data stream is a TLS data stream, and the security protection device generates, based on a packet field of a Hello packet (TLS ClientHello) of the TLS data stream, a fingerprint corresponding to the first data stream. The first data stream includes TLS ClientHello. The security protection device obtains bytes included in some fields in TLS ClientHello, and then connects the bytes to obtain a string. Then, hash calculation is performed on the string by using a hash algorithm (for example, an MD4 algorithm, an MD5 algorithm, or an SHA-1 algorithm), to obtain the fingerprint corresponding to the first data stream. The some fields include any one or more of the following fields: a TLS version in TLS ClientHello, accepted ciphers, lists of extensions, elliptic curves, and elliptic curves point formats.

With reference to the first aspect, in an embodiment, the at least one fingerprint includes at least one first-type fingerprint. That the security protection device generates the at least one fingerprint based on the first rate representation value includes: The security protection device generates the at least one first-type fingerprint when the first rate representation value does not exceed a first rate threshold, where the first-type fingerprint indicates that a data stream that matches the first-type fingerprint is normal traffic.

Further, that the security protection device generates the at least one first-type fingerprint includes: The security protection device generates one first fingerprint for each of the at least one first data stream, and when a quantity of any first fingerprint meets a first condition, determines the any first fingerprint as the first-type fingerprint.

The first condition may include any one or more of the following: the quantity of the any first fingerprint exceeds a first quantity threshold; a proportion of the any first fingerprint exceeds a first proportion threshold; the quantity of the any first fingerprint ranks top M1; a proportion of the any first fingerprint ranks top N1; or an occurrence frequency of the any first fingerprint exceeds a first frequency threshold. M1 and N1 are natural numbers.

In the foregoing embodiment, the security protection device may extract the at least one first fingerprint. Because different first data streams may correspond to a same first fingerprint, in the at least one first fingerprint, some first fingerprints are large in quantity, and some first fingerprints are small in quantity. When the first rate representation value does not exceed the first rate threshold, most or all of first data streams included in the first traffic are normal traffic. Therefore, it may be inferred that there is a high probability that a large quantity of first fingerprints (in other words, first fingerprints that meet the first condition) are fingerprints corresponding to the normal traffic. Therefore, the first-type fingerprint obtained in the foregoing manner may be used to determine that traffic that matches the first-type fingerprint is normal traffic.

In an embodiment, the security protection device obtains a second rate representation value of second traffic in a second time period, and updates the at least one first-type fingerprint when the second rate representation value does not exceed the first rate threshold. The second traffic includes at least one second data stream, and destination IP addresses of all second data streams are the same, or a destination IP address of the at least one second data stream belongs to one IP group.

It should be understood that, in actual application, the first-type fingerprint has time validity. For example, the security protection device determines a first-type fingerprint in the first time period, but a client corresponding to the fingerprint is infected by an attack tool and becomes an attack client in the second time period. In this case, the fingerprint is no longer a first-type fingerprint. In the foregoing embodiment, the security protection device may dynamically update the first-type fingerprint, which improves accuracy of the first-type fingerprint. Correspondingly, when a first-type fingerprint with higher accuracy is used to detect whether a data stream is attack traffic, a detection result is also more accurate.

The second time period is later than the first time period and the second time period is adjacent to the first time period; or the second time period is later than the first time period and both the second time period and the first time period include a common time period.

In other words, the foregoing update may be performed in a periodical manner, or may be performed in a dynamic sliding window manner.

Further, that the security protection device updates the at least one first-type fingerprint includes: The security protection device generates one second fingerprint for each of the at least one second data stream, when a quantity of any second fingerprint meets a second condition, determines the second fingerprint as a new first-type fingerprint, and then replaces the at least one first-type fingerprint with the new first-type fingerprint.

The second condition includes any one or more of the following: the quantity of the any second fingerprint exceeds a second quantity threshold; a proportion of the any second fingerprint exceeds a second proportion threshold; the quantity of the any second fingerprint ranks top M2; a proportion of the any second fingerprint ranks top N2; or an occurrence frequency of the any second fingerprint exceeds a second frequency threshold. M2 and N2 are natural numbers.

In an embodiment, the at least one fingerprint further includes at least one second-type fingerprint. When the second rate representation value exceeds the first rate threshold, the security protection device generates the at least one second-type fingerprint.

Further, that the security protection device generates the at least one second-type fingerprint includes: The security protection device generates one second fingerprint for each of the at least one second data stream, and when a quantity of any second fingerprint meets a third condition and the at least one first-type fingerprint does not include the any second fingerprint, determines the second fingerprint as the second-type fingerprint.

The third condition may include any one or more of the following: the quantity of the any second fingerprint exceeds a third quantity threshold; a proportion of the any second fingerprint exceeds a third proportion threshold; the quantity of the any second fingerprint ranks top M3; a proportion of the any second fingerprint ranks top N3; or an occurrence frequency of the any second fingerprint exceeds a third frequency threshold. M3 and N3 are natural numbers.

In the foregoing embodiment, the security protection device may extract the at least one second fingerprint. Because different second data streams may correspond to a same second fingerprint, in the at least one second fingerprint, some second fingerprints are large in quantity, and some second fingerprints are small in quantity. When the second rate representation value exceeds the first rate threshold, most or all of the second data streams included in the second traffic may be attack traffic. Further, there is a high probability that a large quantity of second fingerprints (in other words, second fingerprints that meet the third condition) are fingerprints corresponding to the attack traffic. The second-type fingerprint obtained in the foregoing manner may be used to determine that traffic that matches the second-type fingerprint is attack traffic.

In addition, when the second rate representation value is greater than the first rate threshold, in addition to the attack traffic, the second traffic may further include normal traffic, and a second fingerprint corresponding to the normal traffic may also meet the third condition. In other words, if the second fingerprint is determined only based on the third condition, the second fingerprint corresponding to the normal traffic may be incorrectly determined as a second-type fingerprint. Therefore, in the foregoing embodiment, in addition to the third condition, the second-type fingerprint is further determined based on the at least one first-type fingerprint. In this way, accuracy of the second-type fingerprint can be further improved.

With reference to the first aspect, in an embodiment, the at least one fingerprint includes at least one second-type fingerprint. That the security protection device generates the at least one fingerprint based on the first rate representation value includes: The security protection device generates the at least one second-type fingerprint when the first rate representation value exceeds a first rate threshold, where the second-type fingerprint indicates that a data stream that matches the any second-type fingerprint is attack traffic.

Further, that the security protection device generates the at least one second-type fingerprint includes: The security protection device generates one first fingerprint for each of the at least one first data stream, and when a quantity of any first fingerprint meets a fourth condition, determines the first fingerprint as one second-type fingerprint.

The fourth condition may include any one or more of the following: the quantity of the any first fingerprint exceeds a fourth quantity threshold; a proportion of the any first fingerprint exceeds a fourth proportion threshold; the quantity of the any first fingerprint ranks top M4; a proportion of the any first fingerprint ranks top N4; or an occurrence frequency of the any first fingerprint exceeds a fourth frequency threshold. M4 and N4 are natural numbers.

It should be understood that when the first rate representation value exceeds the first rate threshold, it indicates that most or all of first data streams included in the first traffic are attack traffic. Therefore, it may be inferred that in the at least one first fingerprint extracted based on the first traffic, there is a high probability that a large quantity of first fingerprints (in other words, first fingerprints that meet the fourth condition) are fingerprints corresponding to the attack traffic. The fingerprint corresponding to the attack traffic may indicate the attack traffic. Therefore, the second-type fingerprint obtained in the foregoing embodiment may indicate the attack traffic.

In an embodiment, the security protection device obtains a second rate representation value of second traffic in a second time period, and updates the at least one second-type fingerprint when the second rate representation value exceeds the first rate threshold. The second traffic includes at least one second data stream, and destination IP addresses of all second data streams are the same, or a destination IP address of the at least one second data stream belongs to one IP group.

Further, that the security protection device updates the at least one second-type fingerprint includes: The security protection device generates one second fingerprint for each of the at least one second data stream, when a quantity of any second fingerprint meets a fifth condition, determines the second fingerprint as a new second-type fingerprint, and then replaces the at least one second-type fingerprint with the new second-type fingerprint.

The fifth condition may include any one or more of the following: the quantity of the any second fingerprint exceeds a fifth quantity threshold; a proportion of the any second fingerprint exceeds a fifth proportion threshold; the quantity of the any second fingerprint ranks top M5; a proportion of the any second fingerprint ranks top N5; or an occurrence frequency of the any second fingerprint exceeds a fifth frequency threshold. M5 and N5 are natural numbers.

It should be understood that, in actual application, the second-type fingerprint has time validity. For example, the security protection device determines a second-type fingerprint in the first time period, a client corresponding to the fingerprint is repaired, and the client does not attack a server after a period of time. In this case, the fingerprint is no longer a second-type fingerprint. In the foregoing embodiment, the security protection device may dynamically update the second-type fingerprint, which improves accuracy of the second-type fingerprint. Correspondingly, when the second-type fingerprint with higher accuracy is used to detect whether a data stream is attack traffic, a detection result is also more accurate.

In an embodiment, the security protection device generates at least one blacklist based on the at least one second-type fingerprint. The blacklist indicates that a data stream that matches the blacklist is attack traffic.

Further, that the security protection device generates the at least one blacklist based on the at least one second-type fingerprint includes: When a request rate or a response rate of one of the at least one first data stream exceeds a second rate threshold, and the at least one second-type fingerprint includes a fingerprint corresponding to the first data stream, the security protection device determines a source IP address of the first data stream as one blacklist. Alternatively, when a request rate of one of the at least one second data stream exceeds a second rate threshold, and the at least one second-type fingerprint includes a fingerprint corresponding to the second data stream, the security protection device determines a source IP address of the second data stream as one blacklist.

In this technical solution, a blacklist is generated based on a second-type fingerprint, so that a security device can determine, by matching a source IP address of a to-be-detected data stream with the blacklist, whether the to-be-detected data stream is attack traffic. Compared with extracting a fingerprint corresponding to a data stream, it consumes less time and resources to obtain the source IP address of the data stream. Therefore, using the at least one blacklist to detect the attack traffic is faster and consumes less resources.

In an embodiment, the security protection device sends the at least one second-type fingerprint to an analysis device. Further, the analysis device may further send the received at least one second-type fingerprint to another security protection device, so that the another security protection device detects attack traffic based on the at least one second-type fingerprint. In this way, security of a network protected by the another security protection device can be improved.

With reference to the first aspect, in an embodiment, when a fingerprint corresponding to a to-be-detected data stream matches any one of the at least one first-type fingerprint, the security protection device permits the data stream; when a fingerprint corresponding to a to-be-detected data stream matches any one of the at least one second-type fingerprint, the security protection device blocks the data stream or performs rate limiting processing on the data stream; or when a source IP address of a to-be-detected data stream matches any one of the at least one blacklist, the security protection device blocks the data stream or performs rate limiting processing on the data stream.

According to a second aspect, this application provides another method for detecting attack traffic. The method may be applied to an analysis device. The analysis device separately receives second-type fingerprint databases sent by a plurality of security protection devices. Each second-type fingerprint database includes at least one second-type fingerprint, and any second-type fingerprint indicates that a data stream that matches the any second-type fingerprint is attack traffic. Then, the analysis device generates a total fingerprint database based on the plurality of received second-type fingerprint databases. The total fingerprint database includes a part or all of second-type fingerprints in the plurality of second-type fingerprint databases. Then, the analysis device sends the total fingerprint database to the plurality of security protection devices, to enable the plurality of security protection devices to detect attack traffic based on the total fingerprint database. In this way, the plurality of security protection devices can obtain a more comprehensive and more accurate second-type fingerprint, thereby improving security of a network protected by each security protection device.

According to a third aspect, this application provides a security protection device. The security protection device includes an obtaining module and a fingerprint generation module. The obtaining module is configured to obtain a first rate representation value of first traffic in a first time period. The first traffic includes at least one first data stream, and destination IP addresses of all first data streams are the same, or a destination IP address of the at least one first data stream belongs to one IP group. The fingerprint generation module is configured to generate at least one fingerprint based on the first rate representation value. Each fingerprint is generated based on a packet field of one of the at least one first data stream, and any fingerprint is used to detect whether a data stream that matches the any fingerprint is attack traffic.

With reference to the third aspect, in an embodiment, the first data stream is a TLS data stream, and the fingerprint generation module generates, based on a packet field of a Hello packet (TLS ClientHello) of the TLS data stream, a fingerprint corresponding to the first data stream. The first data stream includes TLS ClientHello. The fingerprint generation module obtains bytes included in some fields in TLS ClientHello, and then connects the bytes to obtain a string. Then, hash calculation is performed on the string by using a hash algorithm (for example, an MD4 algorithm, an MD5 algorithm, or an SHA-1 algorithm), to obtain the fingerprint corresponding to the first data stream. The some fields include any one or more of the following fields: a TLS version in TLS ClientHello, accepted ciphers, lists of extensions, elliptic curves, and elliptic curves point formats.

With reference to the third aspect, in an embodiment, the at least one fingerprint includes at least one first-type fingerprint. The fingerprint generation module is configured to generate the at least one first-type fingerprint when the first rate representation value does not exceed a first rate threshold. The first-type fingerprint indicates that a data stream that matches the first-type fingerprint is normal traffic.

Further, the fingerprint generation module is configured to: generate one first fingerprint for each of the at least one first data stream, and when a quantity of any first fingerprint meets a first condition, determine the any first fingerprint as one first-type fingerprint.

The first condition may include any one or more of the following: the quantity of the any first fingerprint exceeds a first quantity threshold; a proportion of the any first fingerprint exceeds a first proportion threshold; the quantity of the any first fingerprint ranks top M1; a proportion of the any first fingerprint ranks top N1; or an occurrence frequency of the any first fingerprint exceeds a first frequency threshold. M1 and N1 are natural numbers.

In an embodiment, the obtaining module is further configured to obtain a second rate representation value of second traffic in a second time period. The second traffic includes at least one second data stream, and destination IP addresses of all second data streams are the same, or a destination IP address of the at least one second data stream belongs to one IP group. The fingerprint generation module is further configured to update the at least one first-type fingerprint when the second rate representation value does not exceed the first rate threshold.

The second time period is later than the first time period and the second time period is adjacent to the first time period; or the second time period is later than the first time period and both the second time period and the first time period include a common time period.

Further, the fingerprint generation module is configured to: generate one second fingerprint for each of the at least one second data stream, and when a quantity of any second fingerprint meets a second condition, determine the any second fingerprint as a new first-type fingerprint, and replace the at least one first-type fingerprint with the new first-type fingerprint.

The second condition may include any one or more of the following: the quantity of the any second fingerprint exceeds a second quantity threshold; a proportion of the any second fingerprint exceeds a second proportion threshold; the quantity of the any second fingerprint ranks top M2; a proportion of the any second fingerprint ranks top N2; or an occurrence frequency of the any second fingerprint exceeds a second frequency threshold. M2 and N2 are natural numbers.

In an embodiment, the at least one fingerprint further includes at least one second-type fingerprint. The fingerprint generation module is further configured to generate the at least one second-type fingerprint when the second rate representation value exceeds the first rate threshold.

Further, the fingerprint generation module is configured to generate one second fingerprint for each of the at least one second data stream, and when a quantity of any second fingerprint meets a third condition and the at least one first-type fingerprint does not include any second fingerprint, determine the second fingerprint as one second-type fingerprint.

The third condition may include any one or more of the following: the quantity of the any second fingerprint exceeds a third quantity threshold; a proportion of the any second fingerprint exceeds a third proportion threshold; the quantity of the any second fingerprint ranks top M3; a proportion of the any second fingerprint ranks top N3; or an occurrence frequency of the any second fingerprint exceeds a third frequency threshold. M3 and N3 are natural numbers.

With reference to the third aspect, in an embodiment, the at least one fingerprint includes at least one second-type fingerprint. The fingerprint generation module is configured to generate the at least one second-type fingerprint when the first rate representation value exceeds a first rate threshold. The second-type fingerprint indicates that a data stream that matches the any second-type fingerprint is attack traffic.

Further, the fingerprint generation module is configured to: generate one first fingerprint for each of the at least one first data stream, and when a quantity of any first fingerprint meets a fourth condition, determine the any first fingerprint as one second-type fingerprint.

The fourth condition may include any one or more of the following: the quantity of the any first fingerprint exceeds a fourth quantity threshold; a proportion of the any first fingerprint exceeds a fourth proportion threshold; the quantity of the any first fingerprint ranks top M4; a proportion of the any first fingerprint ranks top N4; or an occurrence frequency of the any first fingerprint exceeds a fourth frequency threshold. M4 and N4 are natural numbers.

In an embodiment, the obtaining module is further configured to obtain a second rate representation value of second traffic in a second time period. The second traffic includes at least one second data stream, and destination IP addresses of all second data streams are the same, or a destination IP address of the at least one second data stream belongs to one IP group. The fingerprint generation module is further configured to update the at least one second-type fingerprint when the second rate representation value exceeds the first rate threshold.

Further, the fingerprint generation module is configured to: generate one second fingerprint for each of the at least one second data stream, and when a quantity of any second fingerprint meets a fifth condition, determine the second fingerprint as a new second-type fingerprint, and replace the at least one second-type fingerprint with the new second-type fingerprint.

The fifth condition may include any one or more of the following: the quantity of the any second fingerprint exceeds a fifth quantity threshold; a proportion of the any second fingerprint exceeds a fifth proportion threshold; the quantity of the any second fingerprint ranks top M5; a proportion of the any second fingerprint ranks top N5; or an occurrence frequency of the any second fingerprint exceeds a fifth frequency threshold. M5 and N5 are natural numbers.

In an embodiment, the security protection device further includes a blacklist generation module. The blacklist generation module is configured to generate at least one blacklist based on the at least one second-type fingerprint.

Further, the blacklist generating module is configured to: when a request rate or a response rate of one of the at least one first data stream exceeds a second rate threshold, and the at least one second-type fingerprint includes a fingerprint corresponding to the first data stream, determine, a source IP address of the first data stream as one blacklist. Alternatively, when a request rate of one of the at least one second data stream exceeds a second rate threshold, and the at least one second-type fingerprint includes a fingerprint corresponding to the second data stream, a source IP address of the second data stream is determined as one blacklist.

In an embodiment, the security protection device further includes a sending module. The sending module is configured to send the at least one second-type fingerprint to an analysis device.

With reference to the third aspect, in an embodiment, the security protection device further includes a detection module. The detection module is configured to: determine whether a fingerprint corresponding to a to-be-detected data stream matches any one of the at least one first-type fingerprint, and when the fingerprint corresponding to the to-be-detected data stream matches the one of the at least one first-type fingerprint, notify the sending module to release the data stream. The detection module is further configured to: determine whether a fingerprint corresponding to a to-be-detected data stream matches any one of the at least one second-type fingerprint, and when the fingerprint corresponding to the to-be-detected data stream matches the one of the at least one second-type fingerprint, block the data stream or perform rate limiting processing on the data stream. The detection module is further configured to: determine whether a source IP address of a to-be-detected data stream matches any one of the at least one blacklist, and when the source IP address of the to-be-detected data stream matches the one of the at least one blacklist, block the data stream or perform rate limiting processing on the data stream.

According to a fourth aspect, this application provides an analysis device. The analysis device includes a receiving module, an analysis module, and a sending module. The receiving module is configured to separately receive second-type fingerprint databases sent by a plurality of security protection devices. Each second-type fingerprint database includes at least one second-type fingerprint, and any second-type fingerprint indicates that a data stream that matches the any second-type fingerprint is attack traffic. The analysis module is configured to generate a total fingerprint database based on the plurality of received second-type fingerprint databases. The total fingerprint database includes a part or all of second-type fingerprints in the plurality of second-type fingerprint databases. The sending module is configured to send the total fingerprint database to the plurality of security protection devices, to enable the plurality of security protection devices to detect attack traffic based on the total fingerprint database.

According to a fifth aspect, this application provides a security protection device. The security protection device includes a processor and a memory, and the processor executes computer program code in the memory to implement some or all of the methods described in any one of the first aspect and the embodiments of the first aspect.

According to a sixth aspect, this application provides an analysis device. The analysis device includes a processor and a memory, and the processor executes computer program code in the memory to implement some or all of the methods described in the second aspect.

According to a seventh aspect, this application provides a computer-readable storage medium. The computer storage medium stores computer program code. When the computer program code is executed by a computing device, the computing device performs some or all of the methods described in any one of the first aspect and the embodiments of the first aspect.

According to an eighth aspect, this application provides another computer-readable storage medium. The computer storage medium stores computer program code. When the computer program code is executed by a computing device, the computing device performs some or all of the methods described in the second aspect.

According to a ninth aspect, this application provides a computer program product. The computer program product may be software or a program product that includes instructions and that can run on a computing device, or is stored in any usable medium. When the computer program product runs on at least one computing device, the at least one computing device is enabled to perform some or all of the methods described in any one of the first aspect and the embodiments of the first aspect.

According to a tenth aspect, this application provides another computer program product. The computer program product may be software or a program product that includes instructions and that can run on a computing device, or is stored in any usable medium. When the computer program product runs on at least one computing device, the at least one computing device is enabled to perform some or all of the methods described in the second aspect.

### BRIEF DESCRIPTION OF DRAWINGS

FIG. 1 is a diagram of an application scenario according to an embodiment of this application;

FIG. 2 is a schematic flowchart of a method for detecting attack traffic according to an embodiment of this application;

FIG. 3 is a diagram of generating at least one first-type fingerprint according to an embodiment of this application;

FIG. 4 is another diagram of generating at least one first-type fingerprint according to an embodiment of this application;

FIG. 5 is a diagram of generating at least one second-type fingerprint according to an embodiment of this application;

FIG. 6 is another diagram of generating at least one second-type fingerprint according to an embodiment of this application;

FIG. 7 is a diagram of updating at least one first-type fingerprint according to an embodiment of this application;

FIG. 8 is another diagram of updating at least one first-type fingerprint according to an embodiment of this application;

FIG. 9 is another diagram of generating at least one second-type fingerprint according to an embodiment of this application;

FIG. 10 is another diagram of generating at least one second-type fingerprint according to an embodiment of this application;

FIG. 11 is a diagram of another application scenario according to an embodiment of this application;

FIG. 12 is a schematic flowchart of another method for detecting attack traffic according to an embodiment of this application;

FIG. 13 is a schematic flowchart of a method for defending against a network attack according to an embodiment of this application;

FIG. 14 is a diagram of a structure of a security protection device according to an embodiment of this application;

FIG. 15 is a diagram of a structure of another security protection device according to an embodiment of this application;

FIG. 16 is a diagram of a structure of an analysis device according to an embodiment of this application; and

FIG. 17 is a diagram of a structure of another analysis device according to an embodiment of this application.

### DESCRIPTION OF EMBODIMENTS

The following describes the technical solutions provided in this application with reference to the accompanying drawings.

The terms used in the technical solutions provided in this application are merely intended to describe embodiments, but are not intended to limit this application. Prefix words such as “first” and “second” in embodiments of this application are merely intended to distinguish between different described objects, and impose no limitation on positions, rankings, priorities, quantities, content, or the like of the described objects. For example, if the described object is a “rate threshold”, the ordinal number before “rate threshold” in “first rate threshold” and “second rate threshold” does not limit a value of “rate threshold”. For another example, if the described object is “fingerprint”, the ordinal number before “fingerprint” in “first fingerprint” and “second fingerprint” does not limit a quantity, an extraction manner, and the like of “fingerprints”. For another example, a description manner such as “at least one (or at least one piece or at least one item) of a1, a2, . . . , and an” used in embodiments of this application includes a case in which any one of a1, a2, . . . , and an exists alone, or includes any combination of any plurality of a1, a2, . . . , and an. Each case may exist alone. For example, a description manner of “at least one (or at least one piece or at least one item) of a1, a2, and a3” includes cases in which only a1 exists, only a2 exists, only a3 exists, both a1 and a2 exist, both a1 and a3 exist, both a2 and a3 exist, and both a1, a2, and a3 exist. “A plurality of” means two or more than two. The term “and/or” is used to describe an association relationship between associated objects, and represents that three relationships may exist independently. For example, b1 and/or b2 may represent that only b1 exists, only b2 exists, and both b1 and b2 exist.

As a network communication security problem frequently occurs, security of network communication becomes a current hot topic. During embodiment, encrypting network traffic before transmission is an effective means of improving security of network communication.

There are various manners of encrypting the network traffic. Currently, the network traffic is generally encrypted based on TLS or a Secure Sockets Layer (SSL). It should be noted that although encrypting the network traffic based on the TLS or the SSL can improve security of network communication, DDOS attack defense becomes more difficult.

A DDOS attack is a network attack means, and an attack principle is as follows: An attacker controls a large quantity of zombie hosts in a zombie network to send a large quantity of data streams to a server, to enable the server to be busy processing the data streams from these zombie hosts, and exhaust system resources (including a computing resource, a storage resource, and a network resource) of the server. As a result, the server cannot process a data stream from a normal client. It may be understood that, if the zombie host encrypts, by using the TLS or the SSL, the data stream sent to the server, after a security protection device receives an encrypted data stream, it is difficult for the security protection device to directly parse out data carried in the data stream, and it is difficult to determine whether the data stream is attack traffic.

Embodiments of this application provide a method for detecting attack traffic. In the method, fingerprint extraction is performed on a real-time data stream, to obtain a fingerprint in real time. When attack traffic is detected, it can be determined, only by matching a fingerprint corresponding to a to-be-detected data stream with the foregoing obtained fingerprint, whether the data stream is attack traffic. In the method provided in embodiments of this application, the fingerprint is obtained by using the real-time data stream, and the fingerprint can better reflect a current network attack status. Therefore, compared with a preset fingerprint database in the conventional technology, the fingerprint obtained by using the method provided in embodiments of this application has higher detection accuracy of the data stream. In addition, when the to-be-detected data stream is an encrypted data stream (for example, a TLS data stream), the method provided in embodiments of this application can be used for detection without decrypting the data stream. Therefore, less time and resources are consumed, and impact on user privacy can be further avoided.

The method for detecting attack traffic provided in embodiments of this application may be performed by a security protection device. The security protection device may be a software apparatus, or may be a hardware device, or may be a combination of the software apparatus and the hardware device. When the security protection device is the software apparatus, the security protection device may be a virtual machine (VM) or software having a protection function.

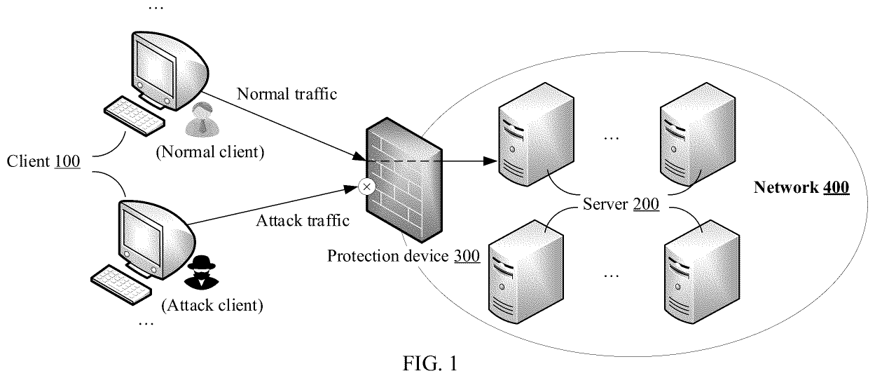

For example, the following briefly describes an application scenario of embodiments of this application with reference to FIG. 1.

FIG. 1 shows an application scenario according to an embodiment of this application. As shown in FIG. 1, the scenario includes a client 100, a server 200, and a security protection device 300. The following briefly describes these parts.

The client 100 includes a normal client and an attack client. The normal client is a client that requests, by generating normal traffic and sending the normal traffic to the server 200, the server 200 to provide a service, for example, a browser or a service client. The attack client is a client that initiates a network attack to the server 200 by generating attack traffic and sending the attack traffic to the server 200, for example, a client that is deployed on a zombie host and that is infected by an attack tool (such as a Trojan horse). In this embodiment of this application, a data stream sent by the attack client to the server 200 is attack traffic, and the attack traffic is used to consume system resources of the server 200. A data stream sent by the normal client to the server 200 is normal traffic, and the normal traffic is normal service traffic, namely, non-attack traffic, and the normal traffic is used to request a service from the server 200.

The server 200 is configured to provide various services such as computing or application for the client 100. The server 200 includes, for example, an application server and a web page server (also referred to as a web server).

The security protection device 300 is configured to protect a network 400, and the network 400 includes at least one server 200. Therefore, the security protection device 300 may protect the at least one server 200 in the network 400, to avoid a network attack initiated by the attack client on the at least one server 200. In one embodiment, before a data stream sent by the client 100 to the server 200 arrives at the server 200, the security protection device 300 first detects whether the data stream is attack traffic. If the data stream is attack traffic, the security protection device 300 blocks the data stream or limits a rate of the data stream. On the contrary, if the data stream is not attack traffic (in other words, is normal traffic), the security protection device 300 permits the data stream.

In some embodiments, the security protection device 300 may include one or any combination of a firewall, a security gateway (such as a router or a switch), an intrusion detection system (IDS) device, an intrusion prevention system (IPS) device, a unified threat management (UTM) device, an anti-virus (AV) device, an anti-DDOS device, or a next generation firewall (NGFW).

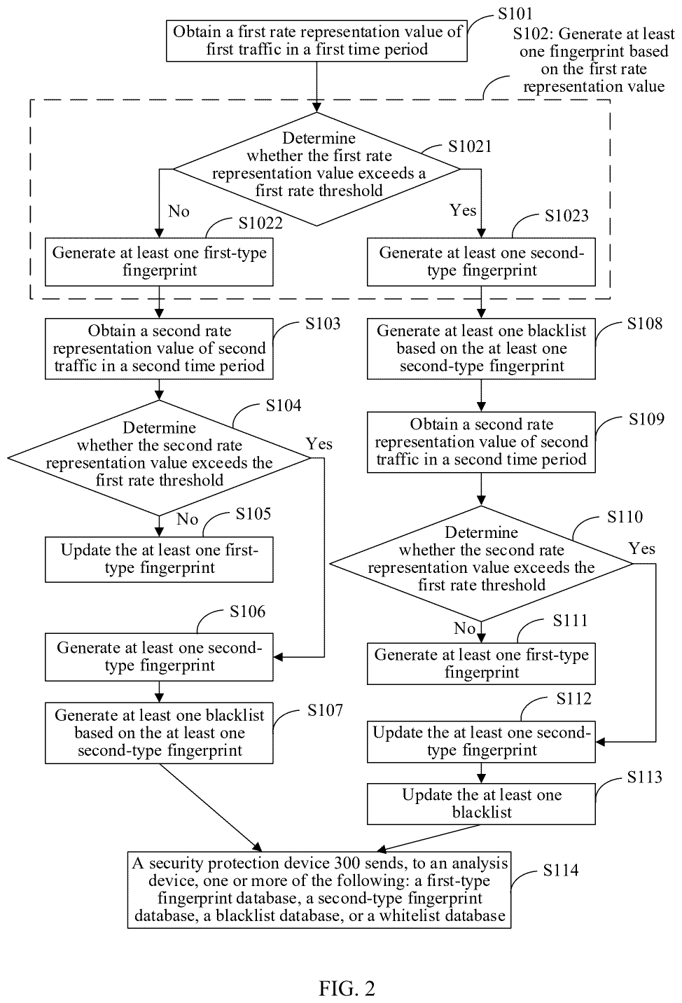

With reference to a schematic flowchart of a method for detecting attack traffic shown in FIG. 2, the following describes in detail how a security protection device 300 detects attack traffic.

S101: The security protection device 300 obtains a first rate representation value of first traffic in a first time period.

The first traffic includes at least one first data stream. In one embodiment, the at least one first data stream includes at least one of a TLS data stream or a data stream encrypted based on an SSL (referred to as an SSL data stream for short below). A source IP address of each of the at least one first data stream may be the same or may be different. In other words, the at least one first data stream is from at least one client 100, and the at least one client 100 may include a normal client, or may include an attack client.

In one embodiment, a destination IP address of each of the at least one first data stream is the same. The destination IP address of the first data stream is referred to as a first IP address for short below, and a server indicated by the first IP address may be any server 200 in a network 400.

In one embodiment, a destination IP address of the at least one first data stream belongs to one IP group (referred to as a first IP group for short below). The first IP group includes one or more IP addresses, and a server indicated by each IP address may be any server 200 in the network 400. During embodiment, the security protection device 300 may divide the IP group in a plurality of manners. For example, the security protection device may group, into one IP group, IP addresses of servers 200 that are in the network 400 and that are configured to provide a same service. Alternatively, the security protection device 300 divides the IP group based on a network segment of the network 400. For example, IP addresses belonging to a same department in an enterprise network are grouped into one IP group. Alternatively, the security protection device 300 divides the IP group based on a configuration of a user. Alternatively, the security protection device 300 groups IP addresses with a same subnet mask into one IP group. Therefore, the first IP group may include a plurality of IP addresses of the servers 200 that are configured to provide the same service, or the first IP group may include a plurality of IP addresses belonging to the same network segment, or the first IP group may include a plurality of IP addresses configured by the user, or the first IP group may include a plurality of IP addresses with the same subnet mask.

The first rate representation value indicates a traffic rate of the first traffic in the first time period. In one embodiment, the first rate representation value may be represented by using a quantity of bytes or a quantity of bits, for example, a total quantity of bytes or a total quantity of bits corresponding to the first traffic in the first time period; or may be represented by using a quantity of bytes or a quantity of bits in a unit time period, for example, an average quantity of bits (BPS) corresponding to the first traffic in the first time period. Alternatively, the first rate representation value may be represented by using a quantity of packets, for example, a total quantity of packets corresponding to the first traffic in the first time period; or may be represented by using a quantity of packets in a unit time period, for example, an average quantity of packets (packets per second, PPS) corresponding to the first traffic in the first time period.

In some embodiments, when the destination IP address of the at least one first data stream in the first traffic is the first IP address, the security protection device 300 determines, based on the first IP address, traffic (namely, the first traffic) sent to the first IP address in the first time period, to obtain the first rate representation value. It may be understood that the security protection device 300 may use each IP address in a network protected by the security protection device 300 as a first IP address, and for each first IP address, the security protection device 300 performs the method provided in this embodiment of this application.

In some embodiments, when the destination IP address of the at least one first data stream in the first traffic belongs to one IP group, the security protection device 300 determines, based on the first IP group, traffic (namely, the first traffic) sent to the first IP group in the first time period, to obtain the first rate representation value. It may be understood that, in this embodiment of this application, a plurality of first IP groups may be set, and for each first IP group, the security protection device performs the method provided in this embodiment of this application.

S102: The security protection device 300 generates at least one fingerprint based on the first rate representation value.

Each of the at least one fingerprint is generated based on a packet field of one of the at least one first data stream. In one embodiment, an example in which the first data stream is a TLS data stream is used. The TLS data stream includes a hello packet (namely, TLS ClientHello) sent by the client 100 to the server 200. Therefore, after receiving the TLS data stream, the security protection device 300 may obtain TLS ClientHello included in the TLS data stream, obtain bytes included in a part of fields in TLS ClientHello, connect these bytes together to obtain a string, and then perform hash calculation on the string by using a hash algorithm (such as an MD4 algorithm, an MD5 algorithm, or an SHA-1 algorithm), to obtain a fingerprint corresponding to the TLS data stream. The part of fields include any one or more of the following fields: a TLS version in TLS ClientHello, accepted ciphers, lists of extension, elliptic curves, and elliptic curve formats.

Any one of the at least one fingerprint is used to detect whether a data stream that matches the any fingerprint is attack traffic. In one embodiment, the at least one fingerprint includes at least one first-type fingerprint, and the first-type fingerprint indicates that a data stream that matches the fingerprint is normal traffic. In one embodiment, the at least one fingerprint includes at least one second-type fingerprint, and the second-type fingerprint indicates that a data stream that matches the fingerprint is attack traffic.

The following describes S102 in detail by using S1021 to S1023.

S1021: The security protection device 300 determines whether the first rate representation value exceeds a first rate threshold. When the first rate representation value does not exceed the first rate threshold, the security protection device 300 performs S1022. In one embodiment, when the first rate representation value exceeds the first rate threshold, the security protection device 300 performs S1023.

The first rate threshold (for example, 1000 PPS or 20000 BPS) may be preset by the user, or may be dynamically adjusted by the security protection device 300 based on an actual situation. For example, the first rate threshold in a traffic peak period may be set to be greater than the first rate threshold in a traffic off-peak period. The traffic peak period and the traffic off-peak period may be determined by the security protection device 300 based on a historical traffic status.

It can be learned from the foregoing descriptions that the first rate representation value may be represented in or more manners, and correspondingly, the first rate threshold may also include one or more thresholds. When the first rate representation value is represented in a plurality of manners, that the security protection device 300 determines whether the first rate representation value exceeds the first rate threshold includes a plurality of embodiments.

For example, it is assumed that the first rate representation value is the average quantity of bits corresponding to the first traffic in the first time period, the first rate threshold is a first average quantity of bits. When the average quantity of bits corresponding to the first traffic in the first time period is greater than the first average quantity of bits, the first rate representation value exceeds the first rate threshold. When the average quantity of bits corresponding to the first traffic in the first time period is less than or equal to the first average quantity of bits, the first rate representation value does not exceed the first rate threshold.

For another example, it is assumed that the first rate representation value is the average quantity of packets corresponding to the first traffic in the first time period, the first rate threshold is a first average quantity of packets. When the average quantity of packets corresponding to the first traffic in the first time period is greater than the first average quantity of packets, the first rate representation value exceeds the first rate threshold. When the average quantity of packets corresponding to the first traffic in the first time period is less than or equal to the first average quantity of packets, the first rate representation value does not exceed the first rate threshold.

For still another example, it is assumed that the first rate representation value includes the average quantity of bits corresponding to the first traffic in the first time period and the average quantity of packets corresponding to the first traffic in the first time period, the first rate threshold includes a first average quantity of bits and a first average quantity of packets. In an embodiment, when the average quantity of bits corresponding to the first traffic in the first time period is less than or equal to the first average quantity of bits, and the average quantity of packets corresponding to the first traffic in the first time period is less than or equal to the first average quantity of packets, the first rate representation value does not exceed the first rate threshold; or when the average quantity of bits corresponding to the first traffic in the first time period is greater than the first average quantity of bits, or the average quantity of packets corresponding to the first traffic in the first time period is greater than the first average quantity of packets, the first rate representation value exceeds the first rate threshold. In another embodiment, when the average quantity of bits corresponding to the first traffic in the first time period is less than or equal to the first average quantity of bits, or the average quantity of packets corresponding to the first traffic in the first time period is less than or equal to the first average quantity of packets, the first rate representation value does not exceed the first rate threshold; or when the average quantity of bits corresponding to the first traffic in the first time period is greater than the first average quantity of bits, and the average quantity of packets corresponding to the first traffic in the first time period is greater than the first average quantity of packets, the first rate representation value exceeds the first rate threshold. In another embodiment, when the average quantity of bits corresponding to the first traffic in the first time period is greater than the first average quantity of bits, or the average quantity of packets corresponding to the first traffic in the first time period is greater than the first average quantity of packets, the first rate representation value exceeds the first rate threshold; otherwise, the first rate representation value does not exceed the first rate threshold.

S1022: The security protection device 300 generates the at least one first-type fingerprint.

In one embodiment, the security protection device 300 generates one first fingerprint for each of the at least one first data stream, and when any first fingerprint meets a first condition, determines the first fingerprint as a first-type fingerprint.

The first condition includes any one or more of the following: a quantity of any first fingerprint exceeds a first quantity threshold; a proportion of any first fingerprint (e.g., a ratio of a quantity of the any first fingerprint to a total quantity of all first fingerprints) exceeds a first proportion threshold; a quantity of any first fingerprint ranks top M1; a proportion of any first fingerprint ranks top N1; or an occurrence frequency of any first fingerprint (in other words, a quantity of any first fingerprint in a unit time period) exceeds a first frequency threshold. M1 and N1 are natural numbers. The first quantity threshold, the first proportion threshold, the first frequency threshold, M1, and N1 may all be preset by the user, or may be dynamically adjusted by the security protection device 300 based on an actual situation.

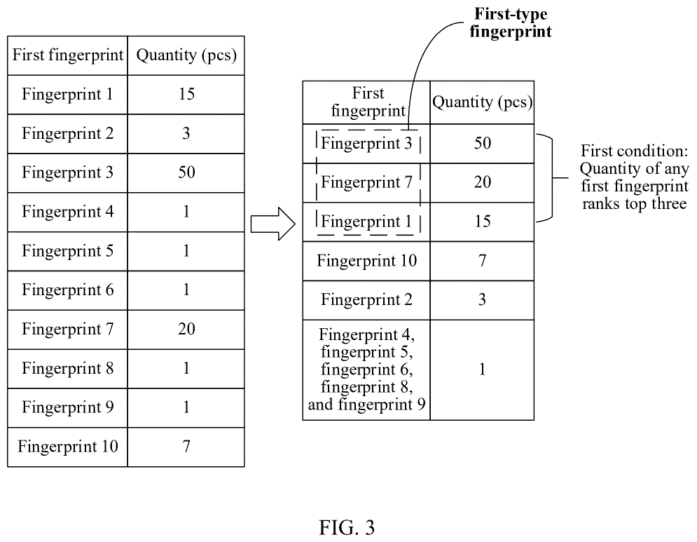

For example, as shown in FIG. 3, the first condition is that the quantity of the any first fingerprint ranks top M1 (where for example, M1=3). The first traffic includes 100 data streams, and destination IP addresses of the 100 data streams are all first IP addresses. The security protection device 300 may obtain 100 first fingerprints after separately performing fingerprint extraction on the 100 data streams. In the 100 first fingerprints, 15 first fingerprints are fingerprints 1, three first fingerprints are fingerprints 2, 50 first fingerprints are fingerprints 3, one first fingerprint is a fingerprint 4, one first fingerprint is a fingerprint 5, one first fingerprint is a fingerprint 6, 20 first fingerprints are fingerprints 7, one first fingerprint is a fingerprint 8, one first fingerprint is a fingerprint 9, and seven first fingerprints are fingerprints 10. The fingerprint 1 to the fingerprint 10 are sorted in descending order of quantities, and it is determined that fingerprints that rank top three are respectively the fingerprint 3, the fingerprint 7, and the fingerprint 1. In this case, the fingerprint 3, the fingerprint 7, and the fingerprint 1 are first-type fingerprints.

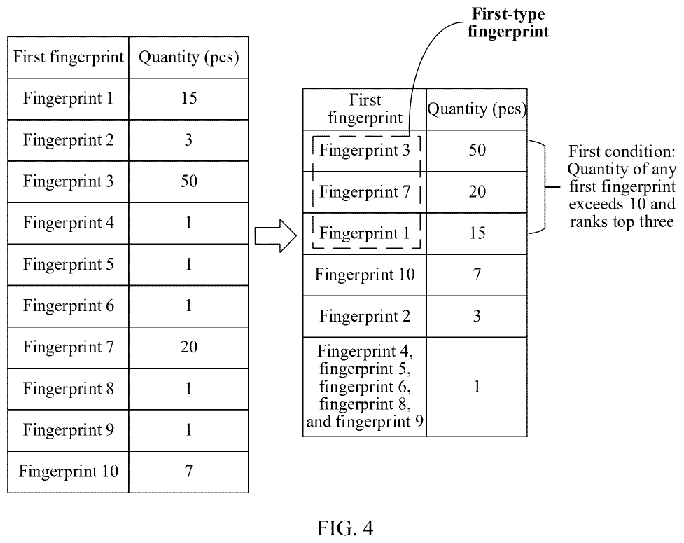

For another example, as shown in FIG. 4, the first condition includes that the quantity of the any first fingerprint exceeds the first quantity threshold (where for example, the first quantity threshold is 10), and the quantity of the any first fingerprint ranks top M1 (where for example, M1=3). The fingerprint 1 to the fingerprint 10 described in FIG. 3 are still used as an example. In the foregoing 10 fingerprints, only quantities of the fingerprints 1, the fingerprints 3, and the fingerprints 7 that rank top three exceed 10. Therefore, the fingerprint 1, the fingerprint 3, and the fingerprint 7 are first-type fingerprints.

It should be understood that the security protection device 300 may extract at least one first fingerprint by performing fingerprint extraction on each first data stream in the first traffic. Different first data streams may correspond to a same first fingerprint. As a result, in the at least one first fingerprint, some first fingerprints are large in quantity, and some first fingerprints are small in quantity. When the first rate representation value does not exceed the first rate threshold, most or all of first data streams included in the first traffic are normal traffic. Therefore, it may be inferred that there is a high probability that a large quantity of first fingerprints (namely, first-type fingerprints) are fingerprints corresponding to the normal traffic. Therefore, the first-type fingerprint obtained in the foregoing manner may be used to determine that traffic that matches the first-type fingerprint is normal traffic.

S1023: The security protection device 300 generates the at least one second-type fingerprint.

In one embodiment, when the first rate representation value exceeds the first rate threshold, the security protection device 300 generates the at least one second-type fingerprint. In one embodiment, the security protection device 300 generates one first fingerprint for each of the at least one first data stream, and when a quantity of any first fingerprint meets a fourth condition, determines the first fingerprint as a second-type fingerprint.

The fourth condition includes any one or more of the following: the quantity of the any first fingerprint exceeds a fourth quantity threshold; a proportion of the any first fingerprint exceeds a fourth proportion threshold; the quantity of the any first fingerprint ranks top M4; a proportion of the any first fingerprint ranks top N4; or an occurrence frequency of the any first fingerprint exceeds a fourth frequency threshold. M4 and N4 are natural numbers. The fourth quantity threshold, the fourth proportion threshold, the fourth frequency threshold, M4, and N4 may all be preset by the user, or may be dynamically adjusted by the security protection device 300 based on an actual situation.

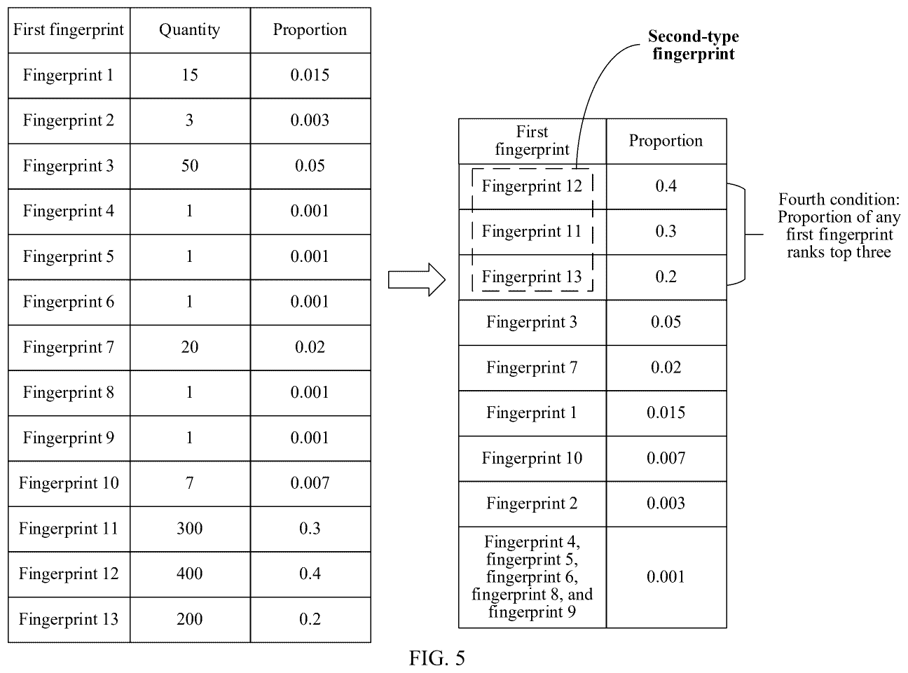

For example, as shown in FIG. 5, the fourth condition is that the proportion of the any first fingerprint ranks top M4 (where for example, M4=3). The first traffic includes 1000 data streams, and destination IP addresses of the 1000 data streams are all first IP addresses. The security protection device 300 may obtain 1000 first fingerprints after separately performing fingerprint extraction on the 1000 data streams. In the 1000 first fingerprints, 15 first fingerprints are fingerprints 1, three first fingerprints are fingerprints 2, 50 first fingerprints are fingerprints 3, one first fingerprint is a fingerprint 4, one first fingerprint is a fingerprint 5, one first fingerprint is a fingerprint 6, 20 first fingerprints are fingerprints 7, one first fingerprint is a fingerprint 8, one first fingerprint is a fingerprint 9, seven first fingerprints are fingerprints 10, 300 first fingerprints are fingerprints 11, 400 first fingerprints are fingerprints 12, and 200 first fingerprints are fingerprints 13. In this case, a proportion of the fingerprints 1 is 0.015 (15/1000), a proportion of the fingerprints 2 is 0.003 (3/1000), a proportion of the fingerprints 3 is 0.05 (50/1000), a proportion of the fingerprint 4, a proportion of the fingerprint 5, a proportion of the fingerprint 6, a proportion of the fingerprint 8, and a proportion of the fingerprint 9 are all 0.001 (1/1000), a proportion of the fingerprints 7 is 0.02 (20/1000), a proportion of the fingerprints 10 is 0.007 (7/1000), a proportion of the fingerprints 11 is 0.3 (300/1000), a proportion of the fingerprints 12 is 0.4 (400/1000), and a proportion of the fingerprints 13 is 0.2 (200/1000). The fingerprint 1 to the fingerprint 13 are sorted in descending order of proportions, and it is determined that fingerprints that rank top three are respectively the fingerprint 12, the fingerprint 11, and the fingerprint 13. In this case, the fingerprint 12, the fingerprint 11, and the fingerprint 13 are second-type fingerprints.

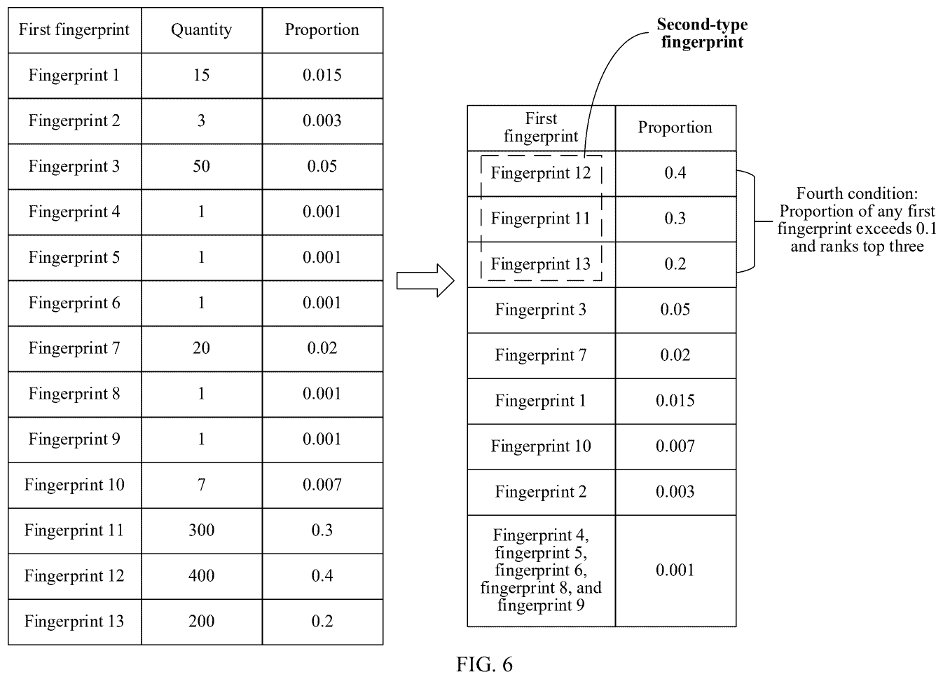

For another example, as shown in FIG. 6, the fourth condition includes that the proportion of the any first fingerprint exceeds the fourth proportion threshold (where for example, the fourth proportion threshold is 0.1), and the proportion of the any first fingerprint ranks top N4 (where for example, N4=3). The fingerprint 1 to the fingerprint 13 described in FIG. 5 are still used as an example. In the foregoing 13 fingerprints, only proportions of the fingerprints 11, the fingerprints 12, and the fingerprints 13 that rank top three exceed 0.1. Therefore, the fingerprint 11, the fingerprint 12, and the fingerprint 13 are second-type fingerprints.

It should be understood that the security protection device 300 may extract at least one first fingerprint by performing fingerprint extraction on each first data stream in the first traffic. Different first data streams may correspond to a same first fingerprint. As a result, in the at least one first fingerprint, some first fingerprints are large in quantity, and some first fingerprints are small in quantity. When the first rate representation value exceeds the first rate threshold, it indicates that most or all of data streams included in the first traffic are attack traffic. Therefore, it may be inferred that there is a high probability that a large quantity of first fingerprints (namely, the second-type fingerprints) are fingerprints corresponding to the attack traffic. The second-type fingerprint obtained in the foregoing manner may be used to determine that traffic that matches the second-type fingerprint is attack traffic.

In one embodiment, after performing S1022, the security protection device 300 may further perform any one or more of the following operations.

S103: The security protection device 300 obtains a second rate representation value of second traffic in a second time period.

The second traffic includes at least one second data stream. In one embodiment, the at least one second data stream includes at least one of the TLS data stream or the SSL data stream. A source IP address of each of the at least one second data stream may be the same or may be different. In other words, the at least one second data stream is from at least one client 100, and the at least one client 100 may include a normal client, or may include an attack client. In addition, a source IP address of any second data stream may be the same as a source IP address of a first data stream, or may be different from source IP addresses of all first data streams.

In one embodiment, a destination IP address of each of the at least one second data stream is the same, and a destination IP address of each second data stream is a first IP address. Alternatively, a destination IP address of the at least one second data stream belongs to one IP group, and the IP group is a first IP group.

In one embodiment, the second time period is later than the first time period and the second time period is adjacent to the first time period. Correspondingly, during embodiment, the security protection device 300 may periodically obtain a rate representation value of traffic sent to the network 400. For example, 1s is a period. When the first time period is 1 ms to 1000 ms, the second time period is 1001 ms to 2000 ms; or when the first time period is 1001 ms to 2000 ms, the second time period is 2001 ms to 3000 ms.

In one embodiment, the second time period is later than the first time period and both the second time period and the first time period include a common time period. Correspondingly, during embodiment, the security protection device 300 may obtain, by using a sliding window, a rate representation value of traffic sent to the network 400. For example, the sliding window is used every 10 ms. When the first time period is 1 ms to 1000 ms, the second time period is 11 ms to 1010 ms; or when the first time period is 11 ms to 1010 ms, the second time period is 21 ms to 1020 ms.

The second rate representation value indicates a traffic rate of the second traffic in the second time period. Similar to the first rate representation value, the second rate representation value may be represented by using a quantity of bytes or a quantity of bits, for example, a total quantity of bytes or a total quantity of bits corresponding to the second traffic in the second time period; or may be represented by using a quantity of bytes or a quantity of bits in a unit time period, for example, an average quantity of bits corresponding to the second traffic in the second time period. Alternatively, the second rate representation value may be represented by using a quantity of packets, for example, a total quantity of packets corresponding to the second traffic in the second time period; or may be represented by using a quantity of packets in a unit time period, for example, an average quantity of packets corresponding to the second traffic in the second time period.

In some embodiments, when the destination IP address of the at least one second data stream in the second traffic is the first IP address, the security protection device 300 determines, based on the first IP address, traffic (namely, the second traffic) sent to the first IP address in the second time period, to obtain the second rate representation value.

In some embodiments, when the destination IP address of the at least one second data stream in the second traffic belongs to the first IP group, the security protection device 300 determines, based on the first IP group, traffic (namely, the second traffic) sent to the first IP group in the second time period, to obtain the second rate representation value.

S104: The security protection device 300 determines whether the second rate representation value exceeds the first rate threshold. When the second rate representation value does not exceed the first rate threshold, the security protection device 300 performs S105; or when the second rate representation value exceeds the first rate threshold, the security protection device 300 performs S106 and S107.

Because the second rate representation value may also be represented in one or more manners, the security protection device 300 may also determine, in one or more manners, whether the second rate representation value exceeds the first rate threshold. For details, refer to the process in which the security protection device 300 determines whether the first rate representation value exceeds the first rate threshold described in S1021. Details are not described herein again.

S105: The security protection device 300 updates the at least one first-type fingerprint.

In one embodiment, the security protection device 300 generates one second fingerprint for each of the at least one second data stream, and when any second fingerprint meets a second condition, determines the second fingerprint as a new first-type fingerprint. Then, the security protection device 300 replaces the at least one first-type fingerprint with the new first-type fingerprint.

The second condition includes any one or more of the following: a quantity of any second fingerprint exceeds a second quantity threshold; a proportion of any second fingerprint (e.g., a ratio of a quantity of any second fingerprint to a total quantity of second fingerprints) exceeds a second proportion threshold; a quantity of any second fingerprint ranks top M2; a proportion of any second fingerprint ranks top N2; or an occurrence frequency of the any second fingerprint (in other words, a quantity of data streams that correspond to any second fingerprint and that are received by the security protection device 300 in a unit time period) exceeds a second frequency threshold. M2 and N2 are natural numbers. The second quantity threshold, the second proportion threshold, the second frequency threshold, M2, and N2 may all be preset by the user, or may be dynamically adjusted by the security protection device 300 based on an actual situation. In some embodiments, the first condition and the second condition may be the same, or may be different. In one embodiment, the first condition and the second condition may be set based on an actual situation. For example, when the first time period is a traffic off-peak period, and the second time period is a traffic peak period, the first quantity threshold in the first condition may be set to be less than the second quantity threshold in the second condition.

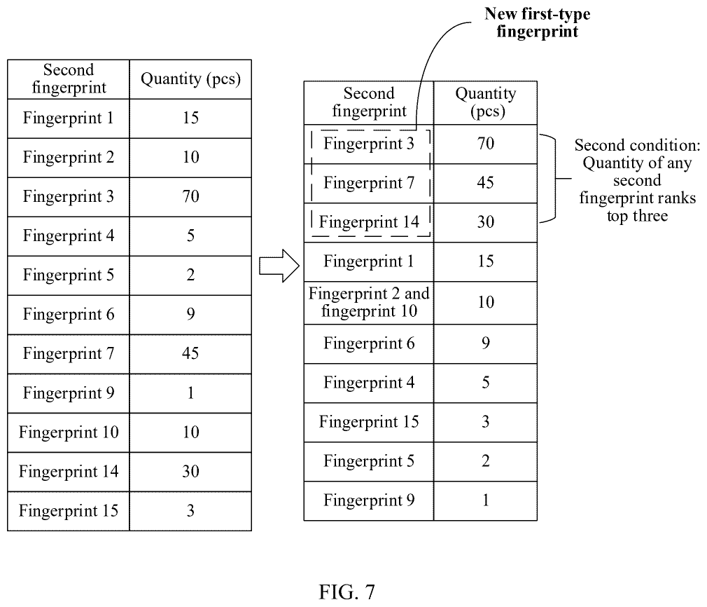

For example, as shown in FIG. 7, the second condition is that the quantity of the any second fingerprint ranks top M2 (where for example, M2=3), the second traffic includes 200 data streams, and destination IP addresses of the 200 data streams are all first IP addresses. The security protection device 300 may obtain 200 second fingerprints after separately performing fingerprint extraction on the 200 data streams. In the 200 second fingerprints, 15 second fingerprints are fingerprints 1, 10 second fingerprints are fingerprints 2, 70 second fingerprints are fingerprints 3, five second fingerprints are fingerprints 4, two second fingerprints are fingerprints 5, nine second fingerprints are fingerprints 6, 45 second fingerprints are fingerprints 7, one fingerprint is a fingerprint 9, 10 fingerprints are fingerprints 10, 30 fingerprints are fingerprints 14, and three fingerprints are fingerprints 15. The foregoing 11 fingerprints are sorted in descending order of quantities, and it is determined that fingerprints that rank top three are respectively the fingerprint 3, the fingerprint 7, and the fingerprint 14. In this case, the fingerprint 3, the fingerprint 7, and the fingerprint 14 are new first-type fingerprints.

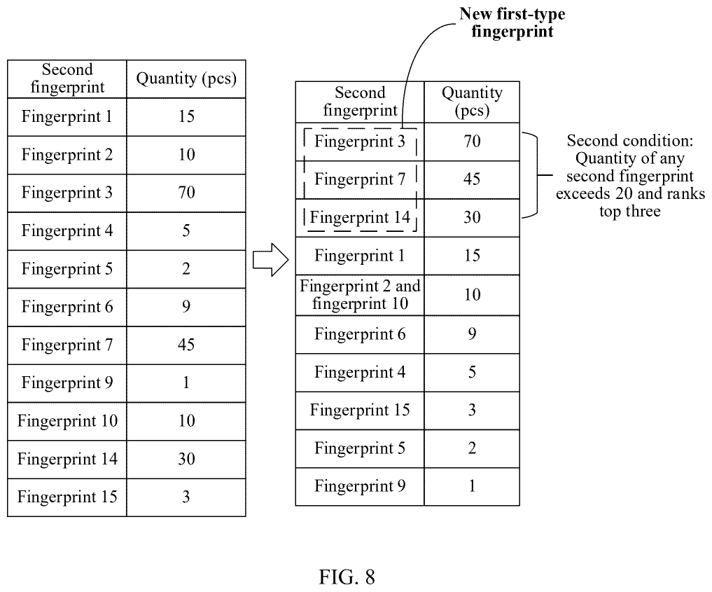

For another example, as shown in FIG. 8, the second condition includes that the quantity of the any second fingerprint exceeds the second quantity threshold (where for example, the second quantity threshold is 20), and the quantity of the any second fingerprint ranks top M2 (where for example, M2=3). The fingerprints described in FIG. 7 are still used as an example. In the foregoing 11 fingerprints, only quantities of the fingerprints 3, the fingerprints 7, and the fingerprints 14 that rank top three exceed 20. Therefore, the fingerprint 3, the fingerprint 7, and the fingerprint 14 are new first-type fingerprints.

It should be understood that, during actual application, the first-type fingerprint has time validity. For example, the security protection device 300 determines a first-type fingerprint in the first time period, but a client corresponding to the fingerprint is infected by an attack tool and becomes an attack client in the second time period. In this case, the fingerprint is no longer the first-type fingerprint. Therefore, the security protection device 300 may update the first-type fingerprint (in other words, perform S105), so that the first-type fingerprint can accurately indicate normal traffic, thereby improving security of the server 200 indicated by the first IP address or the first IP group.

S106: The security protection device 300 generates the at least one second-type fingerprint.

In one embodiment, the security protection device 300 generates one second fingerprint for each of the at least one second data stream, and when any second fingerprint meets a third condition and the at least one first-type fingerprint does not include the second fingerprint, determines the second fingerprint as a second-type fingerprint.

The third condition includes any one or more of the following: a quantity of any second fingerprint exceeds a third quantity threshold; a proportion of any second fingerprint exceeds a third proportion threshold; a quantity of any second fingerprint ranks top M3; a proportion of any second fingerprint ranks top N3; or an occurrence frequency of any second fingerprint exceeds a third frequency threshold. M3 and N3 are natural numbers. The third quantity threshold, the third proportion threshold, the third frequency threshold, M3, and N3 may all be preset by the user, or may be dynamically adjusted by the security protection device 300 based on an actual situation.

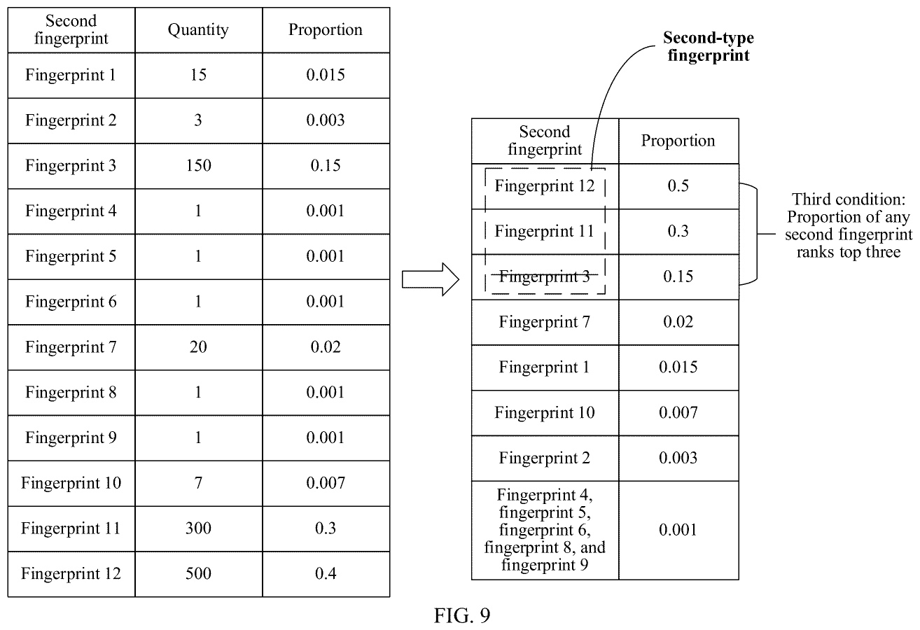

For example, as shown in FIG. 9, the third condition is that the proportion of the any second fingerprint ranks top N3 (where for example, N3=3). The second traffic includes 1000 data streams, and destination IP addresses of the 1000 data streams are all first IP addresses. The security protection device 300 may obtain 1000 second fingerprints after separately performing fingerprint extraction on the 1000 data streams. In the 1000 second fingerprints, 15 second fingerprints are fingerprints 1, three second fingerprints are fingerprints 2, 150 second fingerprints are fingerprints 3, one second fingerprint is a fingerprint 4, one second fingerprint is a fingerprint 5, one second fingerprint is a fingerprint 6, 20 second fingerprints are fingerprints 7, one second fingerprint is a fingerprint 8, one second fingerprint is a fingerprint 9, seven second fingerprints are fingerprints 10, 300 second fingerprints are fingerprints 11, and 500 second fingerprints are fingerprints 12. In this case, a proportion of the fingerprints 1 is 0.015 (15/1000), a proportion of the fingerprints 2 is 0.003 (3/1000), a proportion of the fingerprints 3 is 0.15 (150/1000), a proportion of the fingerprint 4, a proportion of the fingerprint 5, a proportion of the fingerprint 6, a proportion of the fingerprint 8, and a proportion of the fingerprint 9 are all 0.001 (1/1000), a proportion of the fingerprints 7 is 0.02 (20/1000), a proportion of the fingerprints 10 is 0.007 (7/1000), a proportion of the fingerprints 11 is 0.3 (300/1000), and a proportion of the fingerprints 12 is 0.5 (500/1000). The fingerprint 1 to the fingerprint 12 are sorted in descending order of proportions, and it is determined that fingerprints that rank top three are the fingerprint 12, the fingerprint 11, and the fingerprint 3. It can be learned from FIG. 3 that the fingerprint 3 is a first-type fingerprint. Therefore, only the fingerprint 12 and the fingerprint 11 are second-type fingerprints.

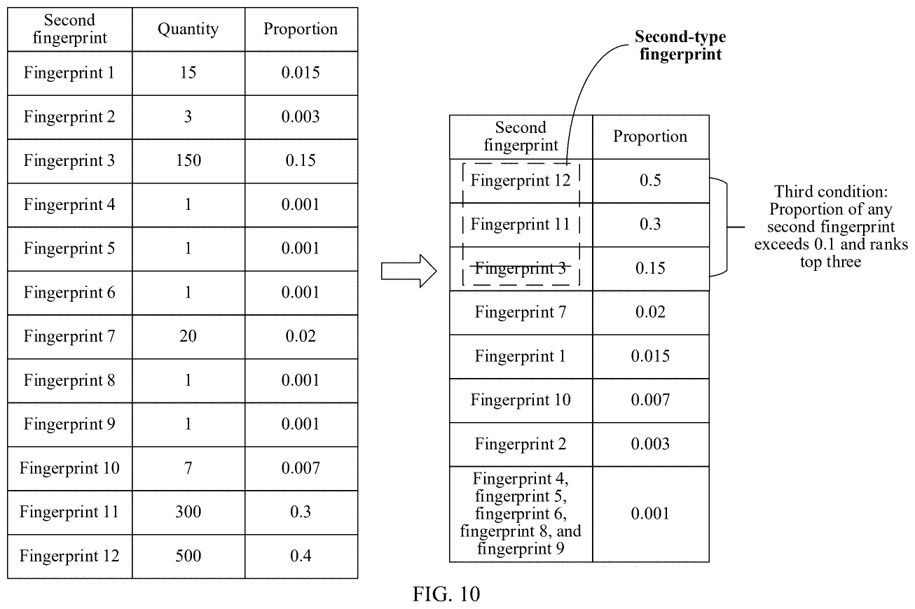

For another example, as shown in FIG. 10, the third condition includes that the proportion of the any second fingerprint exceeds the third proportion threshold (where for example, the third proportion threshold is 0.1), and the proportion of the any second fingerprint ranks top N3 (where N3=3). The fingerprints described in FIG. 9 are still used as an example. In the foregoing fingerprints 1 to fingerprints 12, proportions of the fingerprints 3, the fingerprints 11, and the fingerprints 12 that rank top three exceed 0.1, and the fingerprint 3 is a first-type fingerprint. Therefore, only the fingerprint 11 and the fingerprint 12 are second-type fingerprints.

It should be understood that, in this operation, when whether a second fingerprint is a second-type fingerprint is determined, in addition to determining whether the second fingerprint meets the third condition, whether the second fingerprint is the at least one first-type fingerprint obtained in S1022 needs to be further determined. This is because when the second rate representation value of the second traffic is greater than the first rate threshold, it indicates that the second traffic includes attack traffic, but in addition to the attack traffic, the second traffic may further include normal traffic, and a second fingerprint corresponding to the normal traffic may also meet the third condition, in other words, if the second fingerprint is determined only based on the third condition, the second fingerprint corresponding to the normal traffic may be incorrectly determined as a second-type fingerprint. Therefore, the second fingerprint is determined with reference to the third condition and the at least one first-type fingerprint obtained in S1022, so that accuracy of the second-type fingerprint can be further improved.

S107: The security protection device 300 generates at least one blacklist based on the at least one second-type fingerprint.

In one embodiment, the security protection device 300 obtains a request rate (or a response rate) of each of the at least one second data stream, and when a request rate (or a response rate) of one of the at least one second data stream exceeds a second rate threshold, and the at least one second-type fingerprint includes a fingerprint corresponding to the second data stream, determines a source IP address of the second data stream as one of the at least one blacklist.

The request rate of the second data stream is a rate at which the source IP address of the second data stream initiates a request to a destination IP address of the second data stream in the second time period. In one embodiment, the request rate of the second data stream may be represented by using a quantity of bits in a unit time period, for example, a quantity of bits sent per second by the source IP address of the second data stream to the destination IP address of the second data stream in the second time period. Alternatively, the request rate of the second data stream may be represented by using a quantity of packets in a unit time period, for example, a quantity of packets sent per second by the source IP address of the second data stream to the destination IP address of the second data stream in the second time period.

The response rate of the second data stream is a rate at which the destination IP address of the second data stream responds to the source IP address of the second data stream in the second time period, for example, a rate at which the destination IP address of the second data stream returns an acknowledge character (ACK) to the source IP address of the second data stream.

The second rate threshold (for example, 100 PPS) may be preset by the user, or may be dynamically adjusted by the security protection device 300 based on an actual situation. For example, the second rate threshold in a traffic peak period is greater than the second rate threshold in a traffic off-peak period.

For example, the example described in FIG. 9 is still used. It is assumed that rates at which source IP addresses of second data streams corresponding to the fingerprint 1 to the fingerprint 10 initiate requests to the first IP address are all less than the second rate threshold, rates at which source IP addresses of second data streams corresponding to the fingerprint 11 and the fingerprint 12 initiate requests to the server indicated by the first IP address are both greater than the second rate threshold, and the fingerprint 11 and the fingerprint 12 are second-type fingerprints. In this case, the security protection device 300 determines the source IP address of the second data stream corresponding to the fingerprint 11 and the source IP address of the second data stream corresponding to the fingerprint 12 as blacklists.

The blacklist is generated based on the second-type fingerprint, so that the security device can determine, by matching a source IP address of a to-be-detected data stream with the blacklist, whether the to-be-detected data stream is attack traffic. Compared with extracting a fingerprint corresponding to a data stream, it consumes less time and resources to obtain the source IP address of the data stream. Therefore, using the at least one blacklist to detect the attack traffic is faster and consumes less resources.

During actual application, in addition to the foregoing blacklist, the security protection device 300 may further generate at least one whitelist based on the at least one first-type fingerprint. In one embodiment, when a request rate (or a response rate) of one of the at least one first data stream does not exceed a third rate threshold, and the at least one first-type fingerprint includes a fingerprint corresponding to the first data stream, a source IP address of the first data stream is determined as a whitelist. The third rate threshold may be preset by the user, or may be dynamically adjusted by the security protection device 300 based on an actual situation. In addition, for descriptions of the request rate (or the response rate) of the first data stream, refer to related descriptions in S108 below.

It should be understood that, during actual application, similar to the first-type fingerprint, the whitelist also has time validity. Therefore, after updating the first-type fingerprint, the security protection device 300 may further perform an operation of updating the at least one whitelist. In one embodiment, when a request rate (or a response rate) of one of the at least one second data stream does not exceed a fourth rate threshold, and the new first-type fingerprint includes a fingerprint corresponding to the second data stream, the security protection device 300 determines a source IP address of the second data stream as a new whitelist. The fourth rate threshold may be preset by the user, or may be dynamically adjusted by the security protection device 300 based on an actual situation. Then, the security protection device 300 replaces the at least one whitelist with the new whitelist. In this way, the whitelist can accurately indicate normal traffic, thereby improving security of the server 200 indicated by the first IP address or the first IP group.

In one embodiment, after performing S1023, the security protection device 300 may further perform any one of the following operations.

S108: The security protection device 300 generates at least one blacklist based on the at least one second-type fingerprint.

In one embodiment, the security protection device 300 obtains a request rate (or a response rate) of each of the at least one first data stream, and when a request rate (or a response rate) of one of the at least one first data stream exceeds a second rate threshold, and the at least one second-type fingerprint includes a fingerprint corresponding to the first data stream, determines a source IP address of the first data stream as one of the at least one blacklist.

The request rate of the first data stream is a rate at which the source IP address of the first data stream initiates a request to a destination IP address of the first data stream in the first time period. Similar to the request rate of the second data stream, the request rate of the first data stream may be represented by using a quantity of bits in a unit time period, for example, a quantity of bits sent per second by the source IP address of the first data stream to the destination IP address of the first data stream in the first time period. Alternatively, the request rate of the first data stream may be represented by using a quantity of packets in a unit time period, for example, a quantity of packets sent per second by the source IP address of the first data stream to the destination IP address of the first data stream in the first time period.

The response rate of the first data stream is a rate at which the destination IP address of the first data stream responds to the source IP address of the first data stream in the first time period, for example, a rate at which the destination IP address of the first data stream returns an ACK to the source IP address of the first data stream.

S109: The security protection device 300 obtains a second rate representation value of second traffic in a second time period.

S110: The security protection device 300 determines whether the second rate representation value exceeds the first rate threshold. When the second rate representation value does not exceed the first rate threshold, the security protection device 300 performs S111; or when the second rate representation value exceeds the first rate threshold, the security protection device 300 performs S112 and S113.

An embodiment of S109 and S110 is consistent with an embodiment of S103 and S104. Therefore, details are not described herein again.

S111: The security protection device 300 generates the at least one first-type fingerprint.

In one embodiment, the security protection device 300 generates one second fingerprint for each of the at least one second data stream, and when any second fingerprint meets a second condition, determines the second fingerprint as a first-type fingerprint. For related descriptions of the second condition, refer to the related descriptions in S105.

S112: The security protection device 300 updates the at least one second-type fingerprint.

In one embodiment, the security protection device 300 generates one second fingerprint for each of the at least one second data stream, and when any second fingerprint meets a fifth condition, the security protection device 300 determines the second fingerprint as a new second-type fingerprint. Then, the security protection device 300 replaces the at least one second-type fingerprint with the new second-type fingerprint.

The fifth condition may include any one or more of the following: a quantity of any second fingerprint exceeds a fifth quantity threshold; a proportion of any second fingerprint exceeds a fifth proportion threshold; a quantity of any second fingerprint ranks top M5; a proportion of any second fingerprint ranks top N5; or an occurrence frequency of any second fingerprint exceeds a fifth frequency threshold. M5 and N5 are natural numbers. The fifth quantity threshold, the fifth proportion threshold, the fifth frequency threshold, M5, and N5 may all be preset by the user, or may be dynamically adjusted by the security protection device 300 based on an actual situation.

S113: The security protection device 300 updates at least one blacklist.

In one embodiment, the security protection device 300 obtains a request rate (or a response rate) of each of the at least one second data stream, and when a request rate (or a response rate) of one of the at least one second data stream exceeds a second rate threshold, and the new second-type fingerprint includes a fingerprint corresponding to the second data stream, determines a source IP address of the second data stream as a new blacklist. Then, the security protection device 300 replaces the at least one blacklist with the new blacklist. For related descriptions of the request rate (or the response rate) of the second data stream and the second rate threshold, refer to the related descriptions in S107.

It should be understood that, during actual application, similar to the first-type fingerprint, the second-type fingerprint and the blacklist also have time validity. For example, the security protection device 300 determines a second-type fingerprint in the first time period, but a client corresponding to the fingerprint has been restored to a normal client after a period of time and no longer attacks the server 200. In this case, the fingerprint is no longer the second-type fingerprint. For another example, the security protection device 300 determines a blacklist in the first time period, but an attack client indicated by the blacklist is repaired after a period of time and no longer initiates an attack, and some other originally normal clients become attack clients. Therefore, the security protection device 300 may perform S112 and S113, so that the second-type fingerprint and the blacklist can accurately indicate attack traffic, thereby improving security of the server 200 indicated by the first IP address or the first IP group.

It should be further understood that, for ease of description, the foregoing embodiment does not describe in detail various update cases of the first-type fingerprint, the second-type fingerprint, the blacklist, and the whitelist. However, during actual application, in addition to the cases described in S105, S112, and S113, after performing S106, the security protection device 300 may further perform, based on traffic received in a subsequent time period, the operation of updating the at least one second-type fingerprint. Similarly, after performing S107, the security protection device 300 may further perform, based on the traffic received in the subsequent time period, the operation of updating the at least one blacklist, and after performing S111, perform, based on the traffic received in the subsequent time period, the operations of updating the at least one first-type fingerprint and updating the at least one whitelist. Because embodiments of these operations are similar to the embodiments of S105, S112, and S113, details are not described herein again.

In addition, the foregoing embodiment describes only how the security protection device 300 detects attack traffic for the server 200 indicated by the first IP address or the first IP group, in other words, learns, based on the first traffic and the second traffic whose destination IP address is the first IP address or whose destination IP address belongs to the first IP group, one or more of the following: the at least one first-type fingerprint, the at least one second-type fingerprint, the at least one blacklist, and the at least one whitelist, and then detects, based on one or more of the foregoing learned content, whether a data stream sent to the first IP address or the first IP group is attack traffic. It should be understood that, during actual application, for another IP address (for example, a second IP address) or an IP group (for example, a second IP group) in the network 400, the security protection device 300 may also detect attack traffic by using a method similar to that in S101 to S113. In one embodiment, the second IP address or the second IP group is used for description. The security protection device 300 obtains a rate representation value of third traffic in the first time period, where all destination IP addresses of data streams in the third traffic are second IP address or belong to the second IP group. Then, the security protection device 300 generates at least one first-type fingerprint (or at least one second-type fingerprint) based on the rate representation value of the third traffic. The at least one first-type fingerprint (or the at least one second-type fingerprint) obtained herein is used to detect whether a data stream sent to the second IP address or the second IP group is attack traffic. Further, the security protection device 300 may generate at least one blacklist, at least one whitelist, and the at least one second-type fingerprint (or the at least one first-type fingerprint) for the second IP address or the second IP group with reference to S103 to S113. Then, the security protection device 300 may detect, based on the foregoing learned content, whether the data stream sent to the second IP address or the second IP group is attack traffic.

In other words, the security protection device 300 may correspondingly generate one or more of the at least one first-type fingerprint, the at least one second-type fingerprint, the at least one blacklist, and the at least one whitelist for any one or more servers 200 in the network 400 with reference to S101 to S113, to obtain one or more of a first-type fingerprint database, a second-type fingerprint database, a blacklist database, or a whitelist database. The first-type fingerprint database includes at least one first-type fingerprint, the second-type fingerprint database includes at least one second-type fingerprint, the blacklist database includes at least one blacklist, and the whitelist database includes at least one whitelist.

Further, the security protection device 300 may perform the following operation.

S114: The security protection device 300 sends, to an analysis device, one or more of the following: the first-type fingerprint database, the second-type fingerprint database, the blacklist database, or the whitelist database.

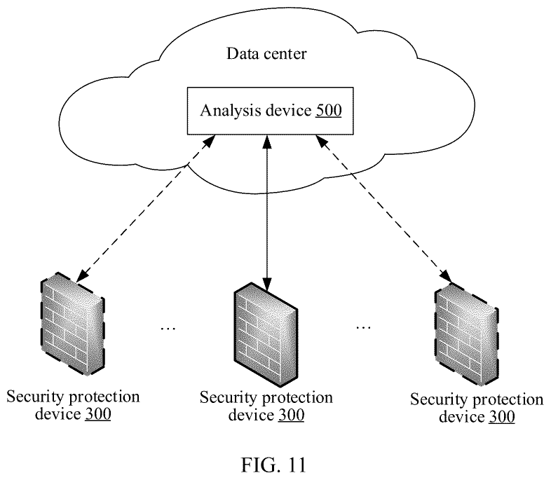

In some embodiments, the analysis device may be an analysis device 500 shown in FIG. 11. The analysis device 500 is deployed in a data center. The data center includes a large quantity of basic resources (including a computing resource, a storage resource, and a network resource). The computing resource included in the data center may be, for example, a computing device of a server, the storage resource may be, for example, a storage device of a hard disk drive, and the network resource may be a network device such as a router or a switch. In one embodiment, the analysis device 500 may be one or more servers in the data center, or may be a software apparatus deployed on a server or a VM in the data center. The software apparatus may be deployed on a plurality of servers in a distributed manner, or deployed on a plurality of VMs in a distributed manner, or deployed on the server and the VM in a distributed manner.

In some embodiments, there are a plurality of security protection devices 300, each security protection device 300 is configured to protect a network 400, and the analysis device 500 is separately connected to the plurality of security protection devices 300. Therefore, the analysis device 500 may further send one or more of the received first-type fingerprint database, second-type fingerprint database, blacklist database, or whitelist database to another security protection device 300. In this way, the another security protection device 300 may also detect attack traffic based on one or more of the first-type fingerprint database, the second-type fingerprint database, the blacklist database, or the whitelist database.

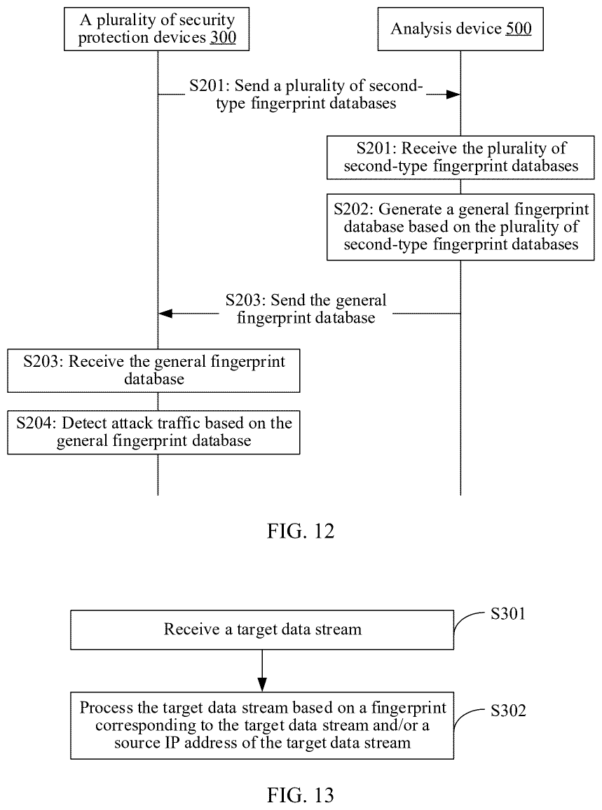

Based on a scenario shown in FIG. 11 and with reference to a schematic flowchart of another method for detecting attack traffic shown in FIG. 12, the following describes, from another aspect, how a security protection device 300 detects attack traffic.

S201: A plurality of security protection devices 300 respectively send second-type fingerprint databases to an analysis device 500, and correspondingly, the analysis device 500 separately receives the second-type fingerprint databases sent by the plurality of security protection devices 300, where each second-type fingerprint database includes at least one second-type fingerprint.

The second-type fingerprint database sent by each security protection device 300 is generated by the security protection device 300 by performing one or more of the foregoing operations S101 to S104, S106, S109, S110, and S112. Therefore, the second-type fingerprint database is not repeatedly described herein again.

S202: The analysis device 500 generates a total fingerprint database based on the plurality of second-type fingerprint databases, where the total fingerprint database includes a part or all of second-type fingerprints in the plurality of second-type fingerprint databases.

In some embodiments, that the analysis device 500 generates the total fingerprint database based on the plurality of second-type fingerprint databases includes: The analysis device 500 adds all second-type fingerprints included in the plurality of second-type fingerprint databases to the total fingerprint database.

In some other embodiments, that the analysis device 500 generates the total fingerprint database based on the plurality of second-type fingerprint databases includes: The analysis device 500 obtains all second-type fingerprints included in the plurality of second-type fingerprint databases, and when an occurrence frequency of any second-type fingerprint exceeds a preset frequency threshold, adds the second-type fingerprint to the total fingerprint database. The occurrence frequency of the any second-type fingerprint is a quantity of second-type fingerprints obtained by the analysis device 500 in a unit time period.

In one embodiment, the analysis device 500 updates the total fingerprint database. In one embodiment, for any second-type fingerprint in the total fingerprint database, the analysis device 500 records time when the second-type fingerprint is added to the total fingerprint database for the first time, and if the analysis device 500 does not obtain the second-type fingerprint for a long time (for example, exceeding a duration threshold), the analysis device 500 deletes the second-type fingerprint from the total fingerprint database.

In one embodiment, for the second-type fingerprint in the total fingerprint database, the analysis device 500 further determines a threat level of each second-type fingerprint based on an occurrence frequency of the second-type fingerprint. A higher occurrence frequency of the second-type fingerprint indicates a higher threat level of the second-type fingerprint, and a higher probability that a data stream that matches the any second-type fingerprint with a higher threat level is attack traffic.

S203: The analysis device 500 sends the total fingerprint database to the plurality of security protection devices 300, and correspondingly, the plurality of security protection devices 300 receive the total fingerprint database sent by the analysis device 500.

S204: The plurality of security protection devices 300 detect attack traffic based on the total fingerprint database.

In one embodiment, a security protection device 300 is used as an example. That the security protection device 300 detects attack traffic based on the total fingerprint database includes: If a fingerprint corresponding to a data stream matches any second-type fingerprint in the total fingerprint database, the security protection device 300 determines that the data stream is attack traffic.

Similar to the second-type fingerprint database, the plurality of security protection devices 300 may further send a plurality of first-type fingerprint databases (where each first-type fingerprint database includes at least one first-type fingerprint), a plurality of blacklist databases (where each blacklist database includes at least one blacklist), or a plurality of whitelist databases (where each whitelist database includes at least one whitelist) to the analysis device 500. Correspondingly, the analysis device 500 may further generate a total first-type fingerprint database based on the plurality of received first-type fingerprint databases, or generate a total blacklist database based on the plurality of received blacklist databases, or generate a total whitelist database based on the plurality of received whitelist databases. Then, the analysis device 500 further sends the total first-type fingerprint database, the total blacklist database, and the total whitelist database to the plurality of security protection devices 300, so that the plurality of security protection devices 300 detect attack traffic. It should be understood that, because the foregoing process is similar to the process described in S201 to S204, details are not described herein again.

With reference to a schematic flowchart of a method for defending against a network attack shown in FIG. 13, the following describes in detail how a security protection device 300 protects, based on one or more of the foregoing obtained at least one first-type fingerprint, at least one second-type fingerprint, at least one blacklist, or at least one whitelist, a server 200 indicated by a first IP address or a first IP group.

S301: The security protection device 300 receives a target data stream.

A destination IP address of the target data stream is a first IP address; or a destination IP address of the target data stream belongs to a first IP group. A source IP address of the target data stream may be at least one client 100.

S302: The security protection device 300 processes the target data stream based on a fingerprint corresponding to the target data stream and/or the source IP address of the target data stream.

(1) The security protection device 300 generates at least one first-type fingerprint, at least one second-type fingerprint, at least one blacklist, and at least one whitelist for the first IP address.

That the security protection device 300 processes the target data stream based on the fingerprint corresponding to the target data stream includes: The security protection device 300 determines, based on the destination IP address of the target data stream, the at least one first-type fingerprint and/or the at least one second-type fingerprint corresponding to the first IP address. The security protection device 300 generates the fingerprint corresponding to the target data stream based on a packet field of the target data stream. If the fingerprint corresponding to the target data stream matches any one of the at least one first-type fingerprint corresponding to the first IP address, the security protection device 300 permits the target data stream, so that the target data stream arrives at the server 200. If the fingerprint corresponding to the target data stream matches any one of the at least one second-type fingerprint corresponding to the first IP address, the security protection device 300 blocks the target data stream, so that the target data stream cannot arrive at the server 200, or the security protection device 300 performs rate limiting processing on the target data stream, so that only a part of traffic of the target data stream arrives at the server 200. For a process in which the security protection device 300 generates the fingerprint corresponding to the target data stream based on the packet field of the target data stream, refer to the fingerprint generation process in S102. Details are not described herein again.

That the security protection device 300 processes the target data stream based on the source IP address of the target data stream includes: The security protection device 300 determines the at least one blacklist and/or the at least one whitelist corresponding to the first IP address based on the destination IP address of the target data stream. The security protection device 300 obtains the source IP address of the target data stream, and if the source IP address of the target data stream matches one of the at least one blacklist corresponding to the first IP address, the security protection device 300 blocks the target data stream or performs rate limiting processing on the target data stream. If the source IP address of the target data stream matches one of the at least one whitelist corresponding to the first IP address, the security protection device 300 permits the target data stream, so that the target data stream arrives at the server 200.

(2) The security protection device 300 generates at least one first-type fingerprint, at least one second-type fingerprint, at least one blacklist, and at least one whitelist for the first IP group.

That the security protection device 300 processes the target data stream based on the fingerprint corresponding to the target data stream includes: The security protection device 300 determines that the destination IP address of the target data stream matches an IP address in the first IP group, and then determines the at least one first-type fingerprint and/or the at least one second-type fingerprint corresponding to the first IP group. The security protection device 300 generates the fingerprint corresponding to the target data stream based on a packet field of the target data stream. If the fingerprint corresponding to the target data stream matches any one of the at least one first-type fingerprint corresponding to the first IP group, the security protection device 300 permits the target data stream, so that the target data stream arrives at the server 200. If the fingerprint corresponding to the target data stream matches any one of the at least one second-type fingerprint corresponding to the first IP group, the security protection device 300 blocks the target data stream or performs rate limiting processing on the target data stream.

That the security protection device 300 processes the target data stream based on the source IP address of the target data stream includes: The security protection device 300 determines that the destination IP address of the target data stream matches an IP address in the first IP group, and then determines the at least one blacklist and/or the at least one whitelist corresponding to the first IP group. The security protection device 300 obtains the source IP address of the target data stream, and if the source IP address of the target data stream matches one of the at least one blacklist corresponding to the first IP group, the security protection device 300 blocks the target data stream or performs rate limiting processing on the target data stream. If the source IP address of the target data stream matches one of the at least one whitelist corresponding to the first IP group, the security protection device 300 permits the target data stream.

(3) The security protection device 300 obtains at least one second-type fingerprint and/or at least one blacklist from an analysis device 500. In this case, the security protection device 300 may match the fingerprint corresponding to the target data stream with the foregoing obtained at least one second-type fingerprint. If the matching succeeds, the security protection device 300 blocks the target data stream or performs rate limiting processing on the target data stream. Alternatively, the security protection device 300 may match the source IP address of the target data stream with the foregoing obtained at least one blacklist, and if the matching succeeds, the security protection device 300 blocks the target data stream or performs rate limiting processing on the target data stream.

It should be understood that, when the target data stream is an encrypted data stream (for example, a TLS data stream or an SSL data stream), in the method described in S301 and S302, how to process the encrypted data stream can be learned by extracting a fingerprint of the encrypted data stream and/or determining a source IP address of the encrypted data stream. Compared with the conventional technology in which how to process an encrypted data stream can be determined only after the encrypted data stream is decrypted, in the method provided in this embodiment of this application, less time and resources are consumed for extracting the fingerprint of the encrypted data stream and/or determining the source IP address of the encrypted data stream, and impact on user privacy can be avoided. In addition, during actual application, when an attack client finds that an attack on a server fails, the attack client generally modifies, by modifying an algorithm list of a cipher suite, a fingerprint of a data stream sent by the client. In this case, if a preset fingerprint database in the conventional technology is used to detect attack traffic, the attack traffic sent by the attack client may not be detected. However, in the method provided in this embodiment of this application, one or more of the at least one first-type fingerprint, the at least one second-type fingerprint, the at least one blacklist, and the at least one whitelist are used to detect attack traffic, and the foregoing items are all dynamically updated. Therefore, detection accuracy of attack traffic is higher.

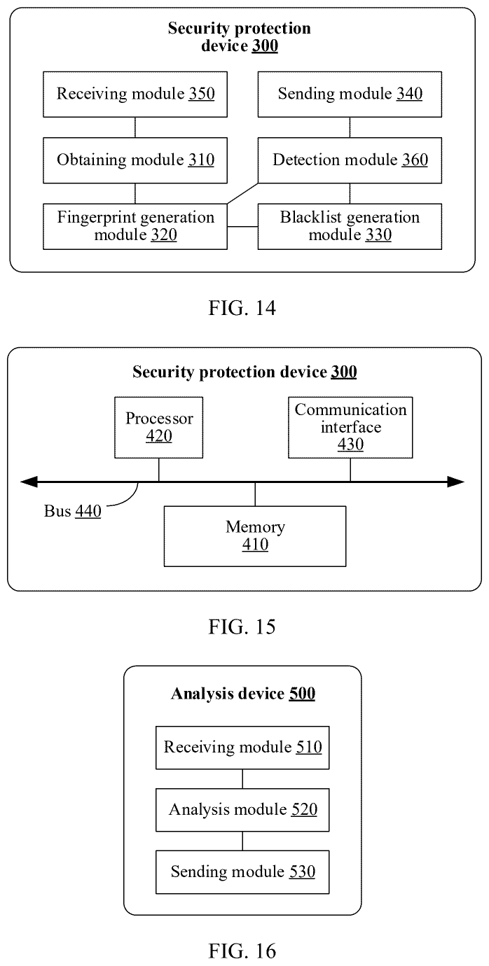

The foregoing describes in detail the method for detecting attack traffic provided in embodiments of this application with reference to FIG. 2 to FIG. 13. The following describes in detail, with reference to FIG. 14 to FIG. 17, the security protection device 300 and the analysis device 500 that implement the foregoing method embodiments from a structural aspect.

FIG. 14 is a diagram of a structure of a security protection device 300. As shown in FIG. 14, the security protection device 300 includes an obtaining module 310 and a fingerprint generation module 320. In one embodiment, the security protection device 300 may further include one or more of a blacklist generation module 330, a sending module 340, a receiving module 350, or a detection module 360. The obtaining module 310 is configured to perform any one or more of S101, S103, and S109. The fingerprint generation module 320 is configured to perform any one or more of S102, S104 to S106, and S110 to S112. The blacklist generation module 330 is configured to perform any one or more of S107, S108, S113, and generating and updating at least one whitelist. The sending module 340 is configured to perform any one or more of sending a first-type fingerprint database, a blacklist database or a whitelist database to an analysis device 500, and permitting normal traffic in S114. The receiving module 350 is configured to perform any one or more of receiving a total fingerprint database sent by an analysis device 500 in S301 and S203, and receiving a total first-type fingerprint database, a total blacklist database, or a total whitelist database sent by an analysis device 500. The detection module 360 is configured to perform any one or more of S204 and S302.

It should be understood that the diagram of the structure shown in FIG. 14 is merely an example of a structure division manner of dividing the security protection device 300 based on functions. A structure division manner of the security protection device 300 is not limited in this embodiment of this application. It should be further understood that the modules in the security protection device 300 may be software modules, or hardware modules, or may be partially software modules and partially hardware modules.

FIG. 15 is another diagram of a structure of a security protection device 300. As shown in FIG. 15, the security protection device 300 includes a memory 410, a processor 420, a communication interface 430, and a bus 440. The memory 410, the processor 420, and the communication interface 430 communicate with each other by using the bus 440. It should be understood that quantities of memories 410, processors 420, and communication interfaces 430 in the security protection device 300 are not limited in this embodiment of this application.

The memory 410 may be a read-only memory (ROM) or another type of static storage device that can store static information and instructions, a random access memory (RAM) or another type of dynamic storage device that can store information and instructions, an electrically erasable programmable read-only memory (EEPROM), a compact disc read-only memory (CD-ROM) or another compact disc storage, an optical disc storage (including a compact disc, a laser disc, an optical disc, a digital versatile disc, a Blu-ray disc, and the like), a magnetic disk storage medium or another magnetic storage device, or any other medium that can be configured to carry or store expected program code in a form of instructions or a data structure and that can be accessed by a computer. However, the memory is not limited thereto. The memory 410 may exist independently, and is connected to the processor 420 by using the bus 440. Alternatively, the memory 410 and the processor 420 may be integrated together.

In some embodiments, the memory 410 stores program code, for example, program code in an obtaining module 310, program code in a fingerprint generation module 320, program code in a blacklist generation module 330, program code in a sending module 340, program code in a receiving module 350, and program code in a detection module 360. When the program code stored in the memory 410 is executed by the processor 420, the processor 420 and the communication interface 430 are configured to perform some or all methods (including one or more operations performed by the security protection device 300 in S101 to S114, S201, S203 and S204, and S301 to S303) performed by the security protection device 300 in the foregoing method embodiments. The memory 410 may further store an operating system and data. The data stored in the memory 410 includes intermediate data, result data, and the like that are generated by the processor 420 in an execution process, for example, a first fingerprint and a first-type fingerprint.

The processor 420 may be a central processing unit (CPU), a graphics processing unit (GPU), a network processor (NP), a microprocessor, or one or more integrated circuits configured to implement the operations performed by the security protection device 300 in the foregoing method embodiments, for example, an application-specific integrated circuit (ASIC), a programmable logic device (PLD), or a combination thereof. The PLD may be a complex programmable logic device (CPLD), a field-programmable gate array (FPGA), a generic array logic (GAL), or any combination thereof.

The communication interface 430 uses any apparatus such as a transceiver, and is configured to communicate with another device or a communications network, for example, receive, by using the communication interface 430, a data stream sent by a client 100 to a server 200, or send normal traffic to a server 200 by using the communication interface 430, or send a second-type fingerprint database to an analysis device 500 by using the communication interface. The communication interface 430 includes a wired communication interface, and may further include a wireless communication interface. The wired communication interface may be, for example, an Ethernet interface. The Ethernet interface may be an optical interface, an electrical interface, or a combination thereof. The wireless communication interface may be a wireless local area network (WLAN) interface, a cellular network communication interface, a combination thereof, or the like.

The bus 440 may include a peripheral component interconnect (PCI) bus, an extended industry standard architecture (EISA) bus, or the like. Buses may be classified into an address bus, a data bus, a control bus, and the like. To facilitate illustration, only one line is used in FIG. 15 to represent the bus, but it does not indicate that there is only one bus or only one type of bus. The bus 440 may include a path for transmitting information between components (for example, the memory 410, the processor 420, and the communication interface 430) of the security protection device 300.

FIG. 16 is a diagram of a structure of an analysis device 500. As shown in FIG. 16, the analysis device 500 includes a receiving module 510, an analysis module 520, and a sending module 530. The receiving module 510, the analysis module 520, and the sending module 530 work together to implement the operations performed by the analysis device 500 in the foregoing method embodiments. In one embodiment, the receiving module 510 is configured to perform any one or more of receiving a plurality of second-type fingerprint databases sent by a plurality of security protection devices 300 and receiving a plurality of first-type fingerprint databases sent by a plurality of security protection devices 300, a plurality of blacklist databases, or a plurality of whitelist databases in S201. The analysis module 520 is configured to perform S202. The sending module 530 is configured to perform any one or more of sending a total fingerprint database to a plurality of security protection devices 300 and sending a total first-type fingerprint database to a plurality of security protection devices 300, a total blacklist database, or a total whitelist database in S203.

It should be understood that the diagram of the structure shown in FIG. 16 is merely an example of a structure division manner of dividing the analysis device 500 based on functions. A structure division manner of the analysis device 500 is not limited in this embodiment of this application. It should be further understood that the modules in the analysis device 500 may be software modules, or hardware modules, or may be partially software modules and partially hardware modules.

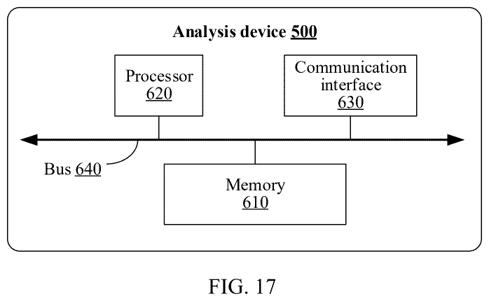

FIG. 17 is another diagram of a structure of an analysis device 500. As shown in FIG. 17, the analysis device 500 includes a memory 610, a processor 620, a communication interface 630, and a bus 640. The memory 610, the processor 620, and the communication interface 630 communicate with each other by using the bus 640. It should be understood that quantities of memories 610, processors 620, and communication interfaces 630 in the analysis device 500 are not limited in this embodiment of this application.

The memory 610 may be a ROM or another type of static storage device that can store static information and instructions, a RAM or another type of dynamic storage device that can store information and instructions, an EEPROM, a CD-ROM or another compact disc storage, an optical disc storage (including a compact disc, a laser disc, an optical disc, a digital versatile disc, a Blu-ray disc, and the like), a magnetic disk storage medium or another magnetic storage device, or any other medium that can be configured to carry or store expected program code in a form of instructions or a data structure and that can be accessed by a computer. However, the memory is not limited thereto. The memory 610 may exist independently, and is connected to the processor 620 by using the bus 640. Alternatively, the memory 610 and the processor 620 may be integrated together.

In some embodiments, the memory 610 stores program code, for example, program code in a receiving module 510, program code in an analysis module 520, and program code in a sending module 530. When the program code stored in the memory 610 is executed by the processor 620, the processor 620 and the communication interface 630 are configured to perform some or all methods (including one or more operations performed by the analysis device 500 in S201 to S203) performed by the analysis device 500 in the foregoing method embodiments. The memory 610 may further store data. The data stored in the memory 610 includes intermediate data, result data, and the like that are generated by the processor 620 in an execution process, for example, a total fingerprint database.

The processor 620 may be a CPU, an NP, a microprocessor, or one or more integrated circuits configured to implement the operations performed by the analysis device 500 in the foregoing method embodiments, for example, an ASIC, a PLD, or a combination thereof. The PLD may be a CPLD, an FPGA, a GAL, or any combination thereof.

The communication interface 630 uses any apparatus such as a transceiver, and is configured to communicate with another device or a communication network, for example, receive, by using the communication interface 430, a second-type fingerprint database sent by a security protection device 300, or send a total fingerprint database to a security protection device 300 by using the communication interface. The communication interface 630 includes a wired communication interface, and may further include a wireless communication interface. The wired communication interface may be, for example, an Ethernet interface. The Ethernet interface may be an optical interface, an electrical interface, or a combination thereof. The wireless communication interface may be a WLAN interface, a cellular network communication interface, a combination thereof, or the like.

The bus 640 may include a PCI bus, an EISA bus, or the like. Buses may be classified into an address bus, a data bus, a control bus, and the like. To facilitate illustration, only one line is used in FIG. 17 to represent the bus, but it does not indicate that there is only one bus or only one type of bus. The bus 640 may include a path for transmitting information between components (for example, the memory 610, the processor 620, and the communication interface 630) of the analysis device 500.

Embodiments of this application further provide a computer-readable storage medium. The computer-readable storage medium may be any usable medium that can be stored by a computing device, or a data storage device, such as a data center, including one or more usable media. The usable medium may be a magnetic medium (such as a floppy disk, a hard disk drive, or a magnetic tape), an optical medium (such as a DVD), a semiconductor medium (such as a solid-state drive), or the like. The computer-readable storage medium includes instructions, where the instructions indicate the computing device to perform the operations performed by the security protection device 300 described above.

In addition, embodiments of this application further provide another computer-readable storage medium. The computer-readable storage medium may be any usable medium that can be stored by a computing device, or a data storage device, such as a data center, including one or more usable media. The computer-readable storage medium includes instructions, where the instructions indicate the computing device to perform the operations performed by the analysis device 500 described above.

Embodiments of this application further provide a computer program product including instructions. The computer program product may be software or a program product that includes instructions and that can run on a computing device, or is stored in any usable medium. When the computer program product runs on at least one computing device, the at least one computing device is enabled to perform the operations performed by the security protection device 300 described above.

In addition, embodiments of this application further provide a computer program product including instructions. The computer program product may alternatively be software or a program product that includes instructions and that can run on a computing device, or is stored in any usable medium. When the computer program product runs on at least one computing device, the at least one computing device is enabled to perform the operations performed by the analysis device 500 described above.

Finally, it should be noted that the foregoing embodiments are merely intended for describing the technical solutions of this application, but not for limiting this application. Although this application is described in detail with reference to the foregoing embodiments, persons of ordinary skill in the art should understand that they may still make modifications to the technical solutions described in the foregoing embodiments or make equivalent replacements to some technical features thereof, without departing from the protection scope of the technical solutions in embodiments of this application.

1. A method for detecting attack traffic, wherein the method comprises:
obtaining a first rate representation value of first traffic in a first time period, wherein the first traffic comprises at least one first data stream, and wherein
destination internet protocol (IP) addresses of all first data streams are the same; or
a destination IP address of the at least one first data stream belongs to a first IP group; and
generating at least one fingerprint based on the first rate representation value, wherein
each of the at least one fingerprint is generated based on a packet field of one of the at least one first data stream; and
any of the at least one fingerprint is used to detect whether a data stream that matching the any of the at least one fingerprint is attack traffic.

2. The method according to claim 1, wherein the at least one fingerprint comprises at least one first-type fingerprint, and the generating the at least one fingerprint comprises:
generating the at least one first-type fingerprint when the first rate representation value does not exceed a first rate threshold, wherein the first-type fingerprint indicates that a data stream matching the first-type fingerprint is normal traffic.

3. The method according to claim 2, wherein the generating the at least one first-type fingerprint comprises:
generating one first fingerprint for each of the at least one first data stream; and
when a quantity of any first fingerprint meets a first condition, determining the any first fingerprint as the first-type fingerprint.

4. The method according to claim 3, wherein the first condition comprises at least one of the following:
the quantity of the any first fingerprint exceeds a quantity threshold;
a proportion of the any first fingerprint exceeds a proportion threshold;
the quantity of the any first fingerprint ranks top M;
a proportion of the any first fingerprint ranks top N; or
an occurrence frequency of the any first fingerprint exceeds a frequency threshold, wherein M and N are natural numbers.

5. The method according to claim 2, wherein the method further comprises:
obtaining a second rate representation value of second traffic in a second time period, wherein
the second traffic comprises at least one second data stream, and destination IP addresses of all second data streams are the same; or
a destination IP address of the at least one second data stream belongs to a second ene IP group, wherein the second IP group may be the same as, or different from, the first IP group; and
updating the at least one first-type fingerprint when the second rate representation value does not exceed the first rate threshold.

6. The method according to claim 5, wherein the updating the at least one first-type fingerprint comprises:
generating one second fingerprint for each of the at least one second data stream;
when a quantity of any second fingerprint meets a second condition, determining the any second fingerprint as a new first-type fingerprint; and
replacing the at least one first-type fingerprint with the new first-type fingerprint.

7. The method according to claim 5, wherein
the second time period is later than the first time period and the second time period is adjacent to the first time period; or
the second time period is later than the first time period and both the second time period and the first time period comprise a common time period.

8. The method according to claim 45, wherein the at least one fingerprint comprises at least one second-type fingerprint, and the generating the at least one fingerprint based on the first rate representation value comprises:
generating the at least one second-type fingerprint when the first rate representation value exceeds a first rate threshold, wherein the second-type fingerprint indicates that a data stream matching any of the least one second-type fingerprint is attack traffic.

9. The method according to claim 8, wherein the method further comprises:
generating at least one blacklist based on the at least one second-type fingerprint.

10. The method according to claim 9, wherein the generating the at least one blacklist further comprises at least one of:
when a request rate or a response rate of one of the at least one first data stream exceeds a second rate threshold, and the at least one second-type fingerprint comprises a fingerprint corresponding to the first data stream, determining a source IP address of the first data stream as one of the at least one blacklist; or
when a request rate or a response rate of one of the at least one second data stream exceeds a second rate threshold, and the at least one second-type fingerprint comprises a fingerprint corresponding to the second data stream, determining a source IP address of the second data stream as one of the at least one blacklist.

11. The method according to claim 8, wherein the method further comprises:
sending the at least one second-type fingerprint to an analysis device.

12. A method for detecting attack traffic, wherein the method comprises:
separately receiving one of a plurality of second-type fingerprint databases from each one of a plurality of security protection devices, wherein each of the plurality of second-type fingerprint databases comprises at least one second-type fingerprint, and any of the at least one second-type fingerprint indicates that a data stream matching the any of the at least one second-type fingerprint is attack traffic;
generating a total fingerprint database based on the plurality of second-type fingerprint databases, wherein the total fingerprint database comprises at least a part of second-type fingerprints in the plurality of second-type fingerprint databases; and
sending the total fingerprint database to the plurality of security protection devices, to enable the plurality of security protection devices to detect attack traffic based on the total fingerprint database.

13. A security protection device, comprising:
a network interface;
a memory storing instructions; and
at least one processor in communication with the network interface and the memory, the at least one processor configured, upon execution of the instructions, to perform the following operations:
obtain a first rate representation value of first traffic in a first time period, wherein the first traffic comprises at least one first data stream, and wherein
destination internet protocol (IP) addresses of all first data streams are the same; or
a destination IP address of the at least one first data stream belongs to one-a first IP group; and
generate at least one fingerprint based on the first rate representation value, wherein
each of the at least one fingerprint is generated based on a packet field of one of the at least one first data stream; and
any of the at least one fingerprint is used to detect whether a data stream matching the any of the least one fingerprint is attack traffic.

14. The security protection device according to claim 13, wherein the at least one fingerprint comprises at least one first-type fingerprint, and wherein the instructions when executed by the at least one processor further cause the device to:
generate the at least one first-type fingerprint when the first rate representation value does not exceed a first rate threshold, wherein the first-type fingerprint indicates that a data stream matching the first-type fingerprint is normal traffic.

15. The security protection device according to claim 14, wherein the instructions when executed by the at least one processor further cause the device to:
generate one first fingerprint for each of the at least one first data stream; and
when a quantity of any first fingerprint meets a first condition, determine the any first fingerprint as the first-type fingerprint.

16. The security protection device according to claim 15, wherein the first condition comprises at least one of the following:
the quantity of the any first fingerprint exceeds a quantity threshold;
a proportion of the any first fingerprint exceeds a proportion threshold;
the quantity of the any first fingerprint ranks top M;
a proportion of the any first fingerprint ranks top N; or
an occurrence frequency of the any first fingerprint exceeds a frequency threshold, wherein M and N are natural numbers.

17. The security protection device according to claim 13, wherein the at least one fingerprint comprises at least one second-type fingerprint, and wherein the instructions when executed by the at least one processor further cause the device to:
generate the at least one second-type fingerprint when the first rate representation value exceeds a first rate threshold, wherein the second-type fingerprint indicates that a data stream matching any of the least one second-type fingerprint is attack traffic.

18. The security protection device according to claim 17, wherein the instructions when executed by the at least one processor further cause the device to:
generate at least one blacklist based on the at least one second-type fingerprint.

19. The security protection device according to claim 18, wherein the instructions when executed by the at least one processor further cause the device to:
when a request rate or a response rate of one of the at least one first data stream exceeds a second rate threshold, and the at least one second-type fingerprint comprises a fingerprint corresponding to the first data stream, determine a source IP address of the first data stream as one of the at least one blacklist; or
when a request rate of at least one second data stream exceeds a second rate threshold, and the at least one second-type fingerprint comprises a fingerprint corresponding to the at least one second data stream, determine a source IP address of the at least one second data stream as one of the at least one blacklist.

20. The security protection device according to claim 17, wherein the instructions when executed by the at least one processor further cause the device to:
send the at least one second-type fingerprint to an analysis device.
